(19) United States
(12) Patent Application Publication
(10) Pub. No.: US 2026/0073407 A1
(43) Pub. Date: Mar. 12, 2026

(54) MACHINE LEARNING RISK MANAGEMENT SYSTEM AND METHOD

(71) Applicant: Michael Peters, Scottsdale, AZ (US)

(72) Inventor: Michael Peters, Scottsdale, AZ (US)

(21) Appl. No.: 19/395,362

(22) Filed: Nov. 20, 2025

Related U.S. Application Data
(63) Continuation-in-part of application No. 18/203,442, filed on May 30, 2023.

(51) Int. Cl. G06Q 30/018; H04L 9/00; H04L 9/40

(52) U.S. Cl. CPC G06Q 30/018; H04L 9/50; H04L 63/0823

(57) ABSTRACT

A modular compliance verification and audit recording system is disclosed. The system includes a plurality of hardware modules interconnected via a system communications bus, a memory storing rule sets, access profiles, and encrypted audit records, and communication circuitry configured to interface with one or more external electronic devices through a secure network gateway. The system receives and authenticates compliance data, applies stored rule sets to determine verification results, records verified events as immutable audit entries, and enforces data-minimization and redaction policies to generate privacy-protected audit information. The processed audit information is transmitted over the secure network gateway to authorized external systems. The system provides end-to-end verification, recording, and privacy preservation of compliance-related data across distributed computing environments.

### CROSS-REFERENCE TO RELATED APPLICATIONS

The current application is a continuation-in-part of U.S. Non-Provisional patent application Ser. No. 18/203,442, filed on May 30, 2023, which in turn is a continuation-in-part of U.S. Non-Provisional patent application Ser. No. 15/230,867, filed on Aug. 8, 2016, each of which is entirely incorporated-by-reference herein.

### FIELD OF THE INVENTION

The present invention relates generally to compliance verification and digital audit technologies. More particularly, the invention is directed to systems and methods for secure, privacy-preserving verification, recording, and transmission of compliance information within distributed computing environments. In embodiments, the invention concerns a modular compliance verification and audit recording system configured to authenticate, validate, and record compliance events while maintaining data integrity and privacy across interconnected networks and external electronic devices.

### BACKGROUND OF THE INVENTION

Compliance and audit infrastructures have evolved into vast digital ecosystems involving thousands of interconnected platforms, remote users, and external vendors. Despite this scale and sophistication, the technical foundation of these systems remains vulnerable to one of the most persistent and costly challenges in the digital era, maintaining privacy and control over sensitive information. Every compliance action generates data: personal identifiers, financial records, security credentials, and operational evidence. As these data move through fragmented systems, they are routinely copied, transferred, and stored across environments that were never engineered for unified oversight. This diffusion has made privacy protection one of the dominant cost drivers in modern compliance management.

The magnitude of the resulting exposure is extraordinary. Data breaches cost organizations an average of over four million dollars per incident, with large-scale or regulated-sector breaches surpassing one billion dollars in direct losses, legal penalties, and reputational damage. In total, worldwide economic losses attributed to compromised compliance and audit data exceed one trillion dollars annually. Consumers suffer parallel harm through identity theft, account manipulation, and erosion of trust in digital services. These outcomes highlight that the problem is a structural failure of current compliance systems to protect the very information they collect and process.

Most existing audit and compliance tools were conceived as data-entry or reporting utilities rather than as privacy-preserving infrastructures. They depend on distributed storage and manual confirmation of regulatory events, often replicating sensitive data across multiple applications without technical boundaries or consistent lifecycle control. Encryption and access control mitigate only part of the risk, because the underlying architectures still permit uncontrolled duplication and transfer of audit information between components. As compliance networks have expanded into hybrid and cloud environments, the number of uncontrolled propagation points has multiplied, increasing the likelihood that private data will be exposed during routine verification and recordkeeping.

The economic, operational, and human consequences of this condition are profound. Enterprises dedicate immense resources to locating, reconciling, and redacting sensitive material after exposure has already occurred. Personnel tasked with privacy and compliance oversight experience high burnout and turnover, reflecting the strain of managing disconnected systems that cannot guarantee where data reside or who has accessed them. These costs, combined with the regulatory penalties imposed for privacy failures, have transformed data protection from a secondary concern into a primary technical limitation of modern audit practice.

Against this backdrop, there exists a long-felt need for a coordinated and technically grounded framework capable of maintaining privacy and data integrity throughout compliance verification and audit recording. Current infrastructures remain dependent on fragmented, record-driven software structures that cannot ensure synchronized, verifiable, or compartmentalized control of sensitive information. This continuing deficiency illustrates a fundamental gap between the scale of modern compliance obligations and the technological capacity of existing systems to protect the information they govern.

### SUMMARY OF THE INVENTION

In embodiments, a modular compliance verification and audit recording system comprises: a system communications bus operatively connected to: an initiation module configured to: receive, over a network via a secure gateway, an incoming compliance data stream from at least one external electronic device, the incoming compliance data stream comprising compliance data, compliance event data, user identifiers, and context metadata; authenticate the incoming compliance data stream by verifying at least one of: compliance data elements based on at least one of a digital signature, cryptographic hash, and authentication token associated with the compliance event data; an identity credential associated with the external electronic device; and a session key associated with the external electronic device; generate, based on the authenticated incoming compliance data stream, an authenticated event stream comprising the authenticated incoming compliance data stream, a verified source identifier, and authentication metadata indicating timestamp, credential validity, and integrity status: and transmit, via the system communications bus, the authenticated event stream to an observation module of the modular compliance verification and audit recording system; the observation module configured to receive, from the initiation module via the system communications bus, the authenticated event stream; generate operational evidence based on the authenticated event stream, the operational evidence comprising system logs, transactional records, and event timestamps; generate, based on the generated operational evidence, an observation data stream comprising the operational evidence and a corresponding verification identifier; and transmit, via the system communications bus, the observation data stream to a verification module of the modular compliance verification and audit recording system; the verification module configured to: access, via the system communications bus, a stored rule set and an associated access control profile stored in memory operably connected to the modular compliance verification and audit recording system; receive, from the observation module via the system communications bus, the observation data stream; validate, based on the access control profile, a permission level associated with the observation data stream; determine a verification result, the verification result comprising a verified state or an exception condition by applying the stored rule set to the observation data stream; generate, based on the verification result, a verification signal transmit, via the system communications bus, the verification signal to a recording module of the modular compliance verification and audit recording system; the recording module configured to receive, from the verification module via the system communications bus, the verification signal, generate, based on the verification signal, an immutable audit record signal comprising the verification signal and the operational evidence; generate, based on the immutable audit record signal, an encrypted and immutable audit record; store, in the memory, the encrypted and immutable audit record; a policy and privacy manager configured to apply, based on a predefined privacy policy and one or more data-classification parameters, a data-minimization filter and a redaction engine to the immutable audit record signal, wherein the data-minimization filter is configured to remove data elements classified as sensitive and the redaction engine configured to mask data fields corresponding to personal or financial identifiers; generate a filtered and redacted output comprising privacy-protected audit information formatted for downstream transmission; and transmit, via the systems communication bus, the filtered and redacted output to a communication module of the modular compliance verification and audit recording system, wherein the filtered and redacted output is configured for network delivery; and a communication module configured to receive, from the policy and privacy manager via the systems communication bus, the filtered and redacted output; generate, based on the fileted and redacted output, an outbound transmission packet comprising the privacy-protected audit information and routing metadata; and transmit the outbound transmission packet over the network via the secure gateway to the external electronic device, wherein the modular compliance verification and audit recording system is configured to maintain privacy and data integrity of compliance information.

In embodiments the secure gateway comprises encryption circuitry configured to establish a cryptographic tunnel for ingress and egress of compliance data.

In embodiments, the authenticated event stream further comprises a digital certificate chain verified by the initiation module.

In embodiments, the verification module applies the stored rule set based on compliance requirements corresponding to one or more regulatory frameworks selected from HIPAA, SOC2, or GDPR.

In embodiments, the recording module utilizes an immutable ledger structure comprising chained record hashes to prevent modification of stored audit records.

In embodiments, the policy and privacy manager further generates a redaction log identifying each field removed or masked in the filtered and redacted output.

In embodiments, the communication module comprises message-authentication circuitry configured to digitally sign the outbound transmission packet prior to transmission.

In embodiments, the memory comprises a partitioned record store with discrete access domains for each of the modules.

In embodiments, the modular compliance verification and audit recording system further comprises an operator console configured to display verification states, exception conditions, and redaction logs generated by the modules.

In embodiments. a computer-implemented method for privacy-preserving compliance verification and audit recording, comprising: receiving, over a network via a secure gateway, an incoming compliance data stream from at least one external electronic device; authenticating the incoming compliance data stream by verifying at least one of a digital signature, cryptographic hash, authentication token, identity credential, or session key associated with the external electronic device; generating an authenticated event stream comprising authentication metadata; generating operational evidence based on the authenticated event stream and transmitting an observation data stream to a verification module; accessing a stored rule set and an associated access-control profile; applying the stored rule set to the observation data stream to determine a verification result comprising a verified state or an exception condition; recording the verification result as an encrypted and immutable audit record; applying a data-minimization filter and a redaction engine to the audit record to generate privacy-protected audit information; and transmitting the privacy-protected audit information over the network via the secure gateway to the external electronic device.

In embodiments, the authenticated event stream comprises authentication metadata comprising credential validity, timestamp, and integrity status.

In embodiments, applying the stored rule set includes validating access rights for the observation data stream prior to rule execution.

In embodiments, recording the verification result includes generating a hash chain across successive audit records.

In embodiments, the redaction engine masks data fields corresponding to personally identifiable information and financial identifiers.

In embodiments, the transmitting step includes digitally signing the privacy-protected audit information.

In embodiments, the method further comprises displaying verification results and redaction logs via an operator console.

In embodiments, a modular compliance verification and audit recording system, comprising: a plurality of hardware modules interconnected via a system communications bus; a memory configured to store rule sets, access profiles, and encrypted audit records; and communication circuitry configured to: receive compliance data from one or more external electronic devices via a secure network gateway; verify and record compliance events as immutable audit records; apply privacy and redaction controls to sensitive data elements; and transmit privacy-protected audit information to authorized external systems, wherein modular compliance verification and audit recording system is operable to provide end-to-end verification, recording, and privacy preservation of compliance-related data across distributed computing environments.

In embodiments, the memory comprises a secure ledger partition configured to maintain integrity validation for each stored audit record.

In embodiments, the communication circuitry authenticates external data sources using cryptographic tokens or certificates.

In embodiments, the plurality of hardware modules include a privacy-management module configured to dynamically enforce data-minimization policies in real time.

### BRIEF DESCRIPTION OF THE DRAWINGS

Exemplary embodiments of the present invention will be described with references to the accompanying figures, wherein:

FIG. 1 presents a flowchart of illustrative operations for applying machine learning in performing governance, risk management and compliance assessment in accordance with an embodiment;

FIG. 2 schematically shows labeled data sets for use in defining supervised training data and user input data that are used for model training in accordance with an embodiment;

FIG. 3 presents a high-level block diagram of a cloud network services architecture for providing governance, risk management and compliance assessment in accordance with an embodiment;

FIG. 4 presents an artificial intelligence machine learning (A.ITAM) system in accordance with an embodiment;

FIG. 5 presents an illustrative user device configured in accordance with an embodiment;

FIG. 6 presents an illustrative architecture for a A.ITAM app in accordance with an embodiment;

FIG. 7 schematically shows an exemplary cascading form use with supervisory and administrator functions in accordance with an embodiment;

FIG. 8 schematically shows an exemplary cascading form use with user functions in accordance with an embodiment;

FIG. 9 presents an illustrative form manager graphical user interface in accordance with an embodiment;

FIG. 10 presents an illustrative existing reports graphical user interface in accordance with an embodiment;

FIG. 11 presents an illustrative risk score report graphical user interface in accordance with an embodiment;

FIG. 12 presents an illustrative compliance score report graphical user interface in accordance with an embodiment;

FIG. 13 presents an illustrative status and risk indicators graphical user interface in accordance with an embodiment;

FIG. 14 presents an illustrative compliance dashboard graphical user interface in accordance with an embodiment;

FIG. 15A is a schematic diagram illustrating a modular compliance verification and audit recording system 11100 and its primary components, in accordance with various embodiments of the present invention;

FIG. 15B is a block diagram illustrating details of observation module 11125, including subcomponents for evidence capture, event timestamping, and state caching, in accordance with various embodiments of the present invention;

FIG. 15C is a block diagram illustrating policy and privacy manager 11135 and associated data-minimization, redaction, and access-control components, in accordance with various embodiments of the present invention;

FIG. 15D is a block diagram illustrating system memory 11140 and associated secure data storage and encryption components, in accordance with various embodiments of the present invention;

FIG. 15E is a block diagram illustrating verification module 11160 and its operational subcomponents, including rule set repository and exception handling logic, in accordance with various embodiments of the present invention;

FIG. 15F is a block diagram illustrating communication module 11170 configured for secure outbound transmission of privacy-protected audit information, in accordance with various embodiments of the present invention;

FIG. 15G is a schematic diagram illustrating network 11180, secure gateway 11185, and external electronic devices 11190 connected to system 11100, in accordance with various embodiments of the present invention;

FIG. 15H is a data-flow diagram illustrating end-to-end communication of compliance data streams between external electronic devices 11190 and modular compliance verification and audit recording system 11100, in accordance with various embodiments of the present invention; and

FIG. 16 is a flowchart illustrating an exemplary process for receiving, authenticating, verifying, recording, and transmitting privacy-protected compliance information using the modular compliance verification and audit recording system 11100, in accordance with various embodiments of the present invention.

### DETAILED DESCRIPTION

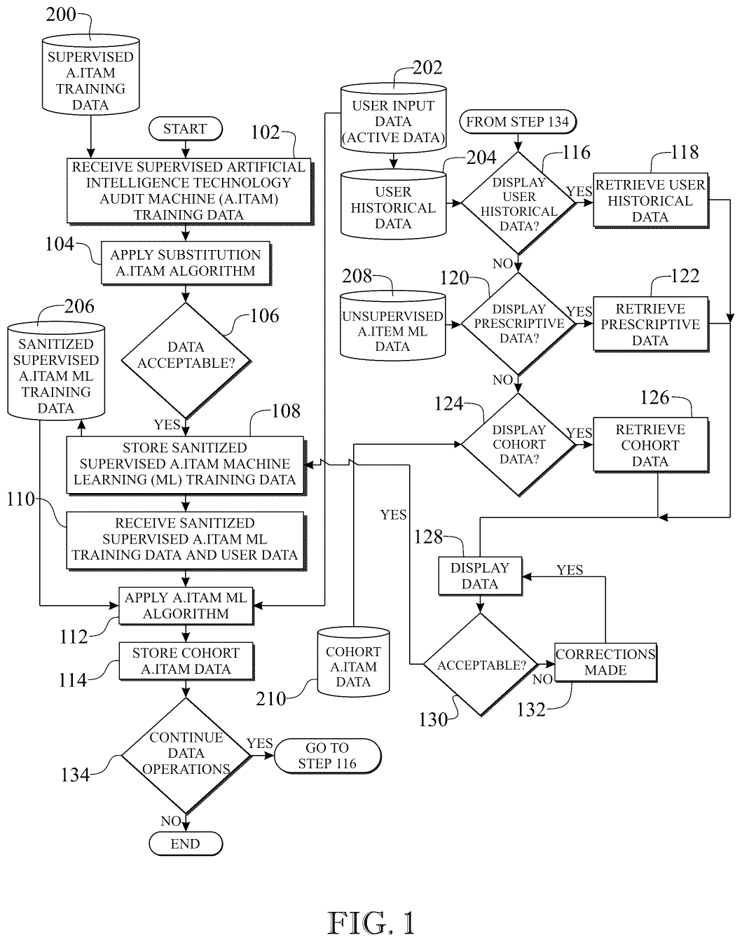

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In embodiments, the present disclosure provides a Modular Compliance Verification and Audit Recording System configured to coordinate, verify, and record compliance activities while maintaining privacy, data isolation, and synchronization across distributed environments. In embodiments, the system comprises a plurality of interrelated modules, communication circuitry, and control logic configured to operate through a shared communication bus and at least one memory structure. The physical and logical interconnection of these elements enables the system to execute compliance verification as an organized, state-controlled process rather than as a series of independent data transactions.

In embodiments, the Modular Compliance Verification and Audit Recording System includes an Initiation Module configured to receive compliance or audit triggers from one or more external sources. The Initiation Module authenticates input events, associates them with predefined compliance parameters stored in the system memory, and generates initiation signals distributed over the communication bus to other modules within the system. In embodiments, a Verification Module is operatively coupled to the Initiation Module and configured to evaluate operational data, confirmation signals, and status indicators received through the communication circuitry. The Verification Module executes a verification routine stored in memory to determine whether a compliance action has been properly executed, producing an output signal representing a verified or exception condition.

In embodiments, an Observation Module is communicatively linked to the Verification Module and is configured to monitor, record, and timestamp system states, user interactions, or automated responses occurring during a compliance event. The Observation Module maintains a secure cache of temporary data in local memory for correlation and cross-verification. In embodiments, a Recording Module receives verified outputs from the Verification Module and produces a non-transitory audit record that is stored in system memory as an immutable entry. The Recording Module may incorporate encryption circuitry and secure-write control logic to prevent unauthorized modification, replication, or export of recorded information, thereby preserving privacy and integrity throughout the audit cycle.

In embodiments, a Communication Module interconnects each of the other modules through the system bus and associated communication circuitry. The Communication Module governs signaling, synchronization, and isolation among modules, ensuring that each exchange of information occurs under controlled conditions and that data packets transmitted between modules are validated before acceptance. The Communication Module may further include routing logic configured to compartmentalize sensitive information, directing only relevant subsets of data to authorized modules, thereby reducing unnecessary propagation of private or regulated information within the system.

In embodiments, the Modular Compliance Verification and Audit Recording System further comprises at least one processor operatively connected to the communication bus and memory. The processor executes control instructions that coordinate module operation and manage timing and state transitions within the system. In embodiments, the memory includes volatile and non-volatile portions configured to store compliance parameters, verification routines, audit records, and access control data. The interaction of the processor, memory, and bus forms the physical control backbone that enables deterministic sequencing and verifiable state transitions between modules.

In embodiments, the modular configuration allows the system to operate as a distributed or centralized platform. In distributed implementations, multiple instances of the modules may reside on different network nodes, communicating through secure transmission pathways that maintain synchronization and data integrity. In centralized embodiments, the modules are co-located and communicate through a shared internal bus, ensuring minimal latency and direct coordination among operational units. In either configuration, the system maintains privacy boundaries by ensuring that sensitive data remain encrypted or compartmentalized during verification, observation, and recording.

In embodiments, the disclosed system provides measurable improvements in privacy protection, audit reliability, and operational integrity. By structuring compliance verification as a coordinated sequence of controlled module interactions rather than as a collection of manual or asynchronous data entries, the system ensures that every recorded compliance state is both technically verified and contextually authentic. This structured organization materially reduces unauthorized data exposure, eliminates redundant verification effort, and provides a continuous, verifiable chain of custody for audit information throughout its lifecycle.

The term authenticity, as used herein, refers to a verifiable assurance that a received or stored data element originates from an identified source and has been transmitted without unauthorized substitution. Authenticity, in this context, encompasses both source validation and transmission verification. Source validation may be achieved through digital signatures, cryptographic key exchanges, or certificate-based identity proofs confirming that the originating device or entity is authorized to generate the compliance event. Transmission verification may include confirming that the data, message, or record has not been intercepted, replayed, or substituted during network transfer. In certain embodiments, authenticity extends to logical origin integrity-ensuring that the recorded event corresponds to a genuine operational occurrence within the monitored system rather than an injected or simulated artifact.

The term integrity, as used herein, refers to the technical assurance that data, once generated, recorded, or transmitted, remains complete, accurate, and unaltered from its verified state. Integrity mechanisms may include hash-based validation, cryptographic checksums, secure write-once storage, and sequential linkage structures that detect modification or omission. In embodiments, integrity also includes temporal and structural coherence: confirming that event order, interdependencies, and contextual metadata remain consistent across verification and recording operations. Integrity further encompasses protection against unauthorized modification at rest and in transit, ensuring that every audit record or compliance event can be reconstructed as an exact representation of its originally verified state.

Confidentiality, as used herein, refers to the controlled restriction of data access and visibility to authorized entities only. It encompasses both proactive prevention of unauthorized disclosure and the use of technical safeguards such as encryption, redaction, and compartmentalized access controls to maintain data secrecy during storage and transmission.

Privacy preservation, as used herein, refers to the maintenance of individual or organizational anonymity and protection of personally identifiable or sensitive information within compliance operations. It may include techniques such as data minimization, pseudonymization, consent-based access, and selective data retention, ensuring that only necessary information is processed or exposed.

Verification, in embodiments, as used herein, refers to a technical process of confirming that a received data element, event, or operational record satisfies one or more predetermined rules, cryptographic criteria, or policy conditions. Verification may involve algorithmic evaluation, digital signature analysis, or application of structured rule sets stored within the system memory.

Immutability, as used herein, refers to the technical property of a data store or audit record that prevents modification, deletion, or reordering of stored entries after they have been written.

Immutability may be achieved through hardware-enforced write-once logic, hash-linked ledger structures, or cryptographic binding mechanisms that ensure any alteration attempt is detectable.

As used herein, the term audit record refers to a structured data object containing verified compliance information, event identifiers, timestamps, and cryptographic validation data. Audit records may be stored sequentially, linked, or indexed to allow reconstruction of verified operational activity, serving as a verifiable technical proof of system behavior.

Compliance data, as used herein, refers to information generated or collected in the course of verifying adherence to operational, regulatory, or security requirements. Such data may include transactional logs, authentication credentials, environmental metadata, or policy references. Compliance data may be structured, semi-structured, or unstructured and may originate from human, device, or automated sources.

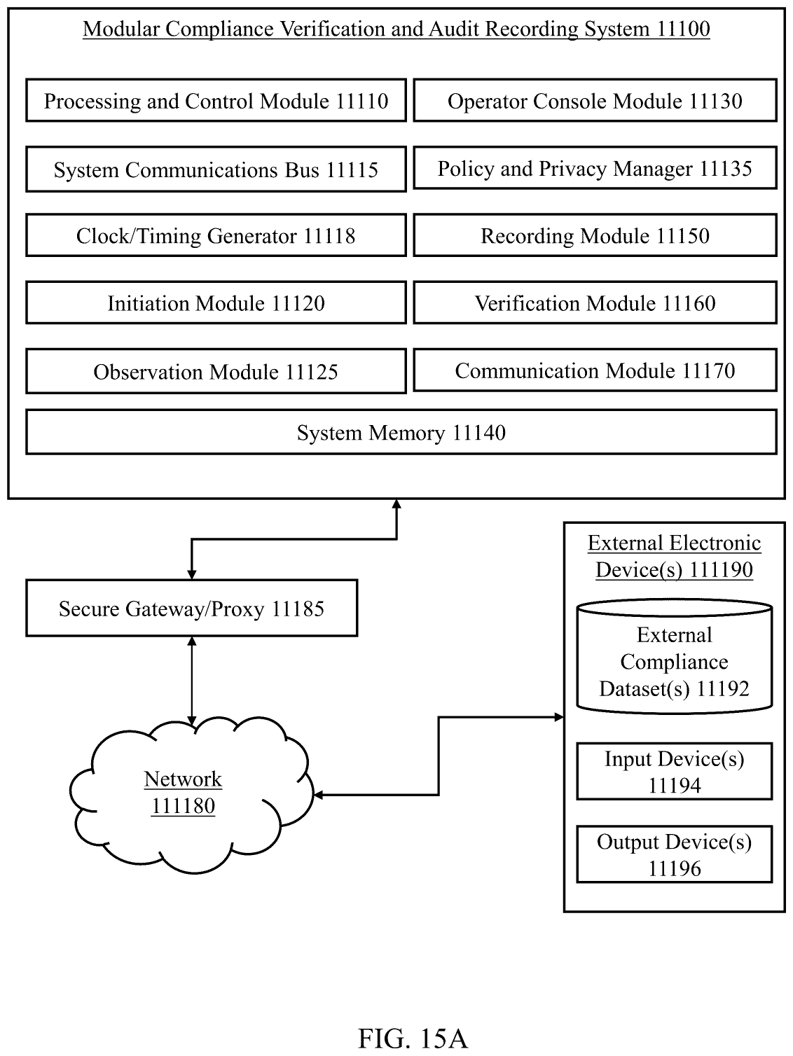

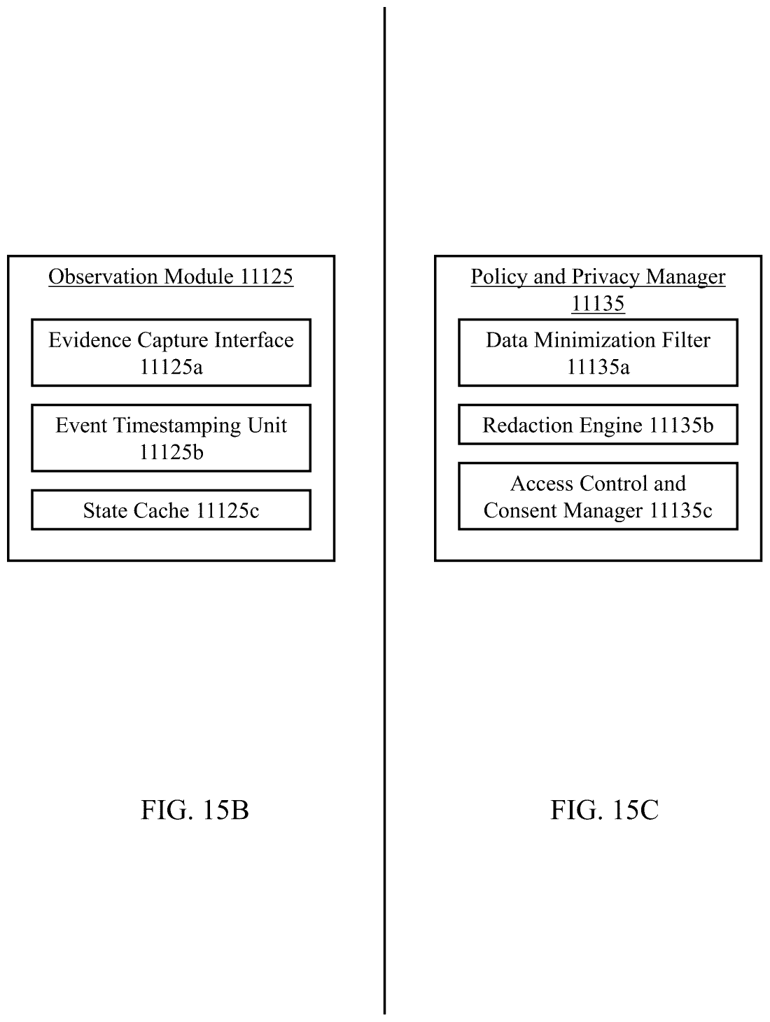

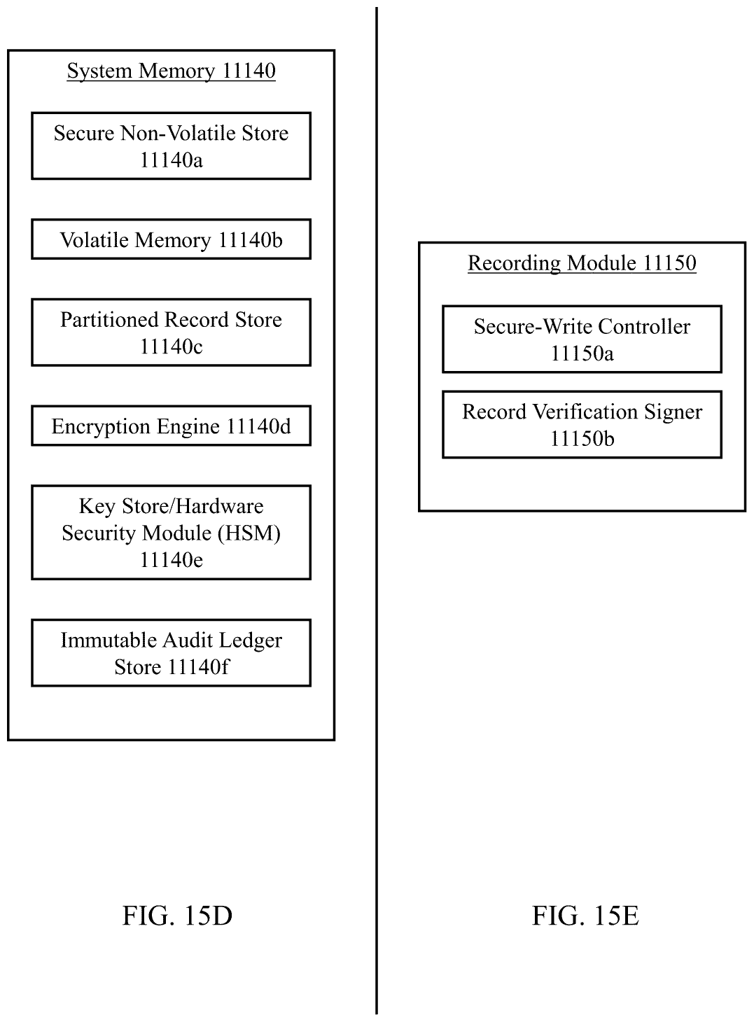

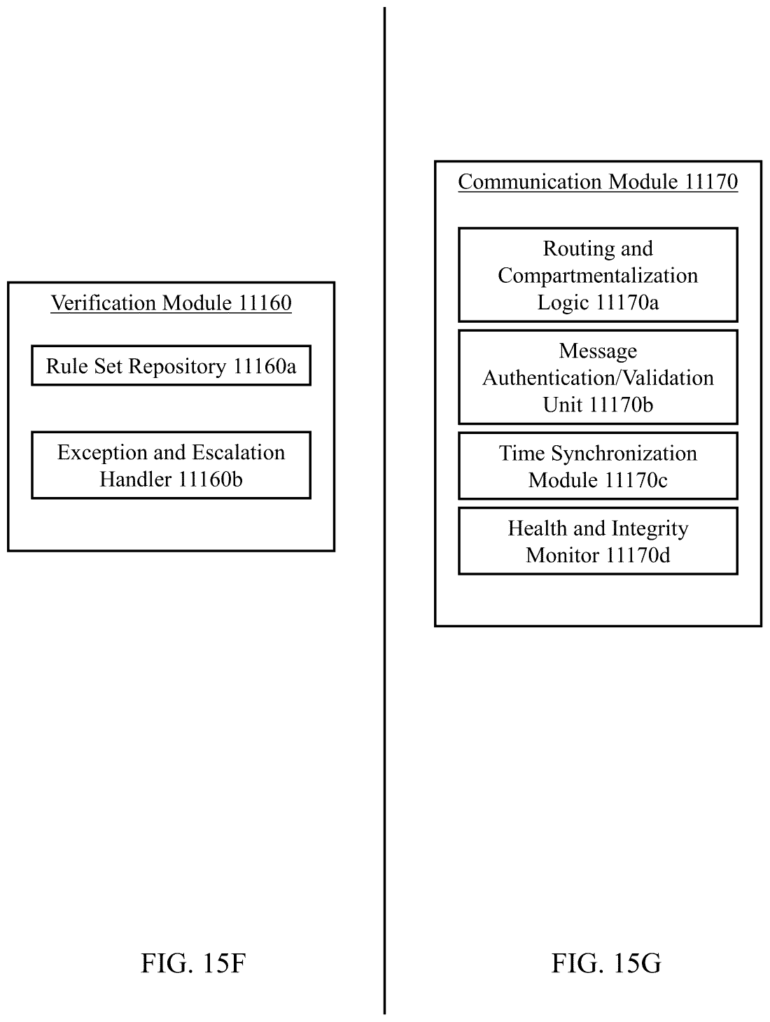

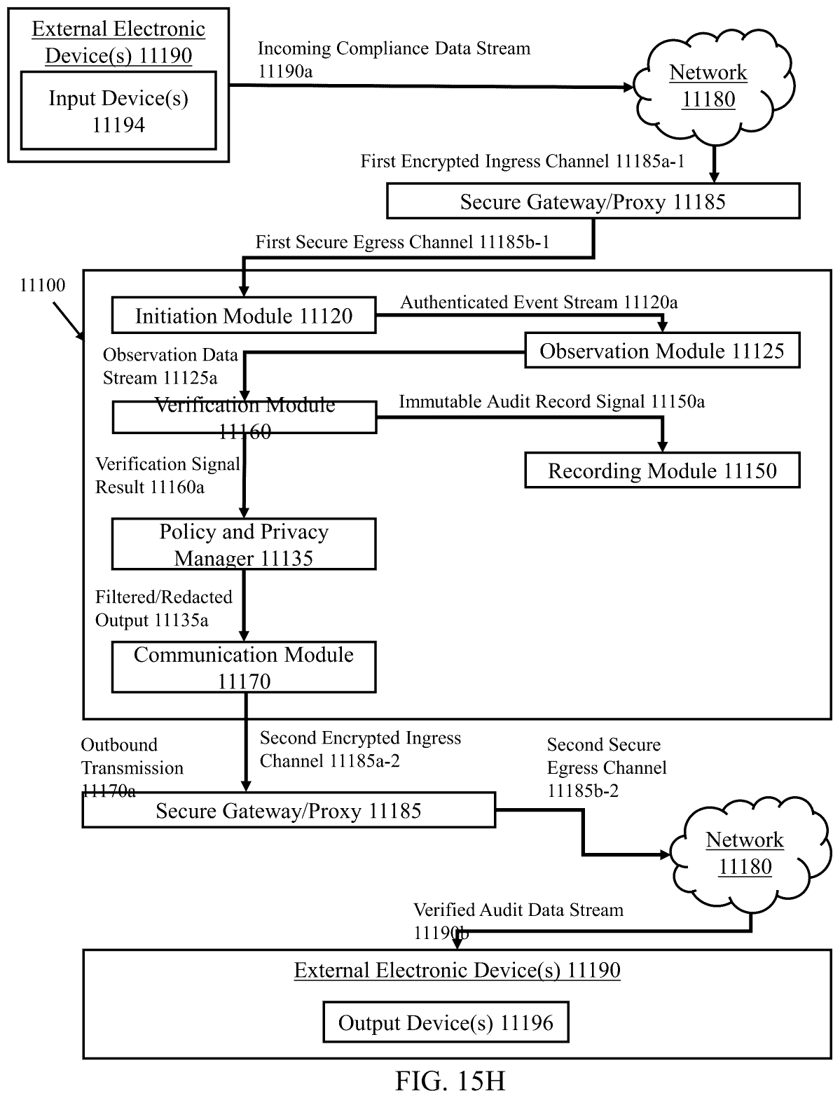

FIG. 15A illustrates a modular compliance verification and audit recording system 11100 in accordance with various embodiments of the present invention. As shown in FIG. 15A, modular compliance verification and audit recording system 11100 communicates with external electronic devices 11190 over network 11180 via secure gateway or proxy 11185. In embodiments, modular compliance verification and audit recording system 11100 includes processing and control module 11110, system communications bus 11115, clock and timing generator 11118, initiation module 11120, observation module 11125, operator console module 11130, policy and privacy manager 11135, system memory 11140, recording module 11150, verification module 11160, and communication module 11170.

In embodiments, the modular compliance verification and audit recording system 11100 comprises processing and control module 11110. Processing and control module 11100, in embodiments, governs overall coordination and execution of operational instructions among the various modules of system 11100. Processing and control module 11110 may include one or more multicore processors, digital signal processors (DSPs), microcontrollers, or field-programmable gate arrays (FPGAs) configured to execute control logic associated with system timing, data routing, and task orchestration. In certain embodiments, processing and control module 11110 includes dedicated co-processors or hardware accelerators configured to perform cryptographic operations, hashing computations, or rule-set evaluation functions to improve processing efficiency during compliance data verification. The module may further include non-transitory firmware or embedded control software stored within on-board flash memory or EEPROM, enabling initialization, inter-module scheduling, and fault recovery procedures. In embodiments, processing and control module 11110 communicates with other modules through system communications bus 11115 using a deterministic message protocol that ensures ordered data delivery and state synchronization across verification, recording, and policy-management operations.

In embodiments, the modular compliance verification and audit recording system 11100 comprises system communications bus 11115. In embodiments, system communications bus 11115 provides the primary data exchange backbone between the functional modules of system 11100. System communications bus 11115 may include a high-speed serial or parallel interconnect, such as a Peripheral Component Interconnect Express (PCIe) bus, Serial RapidIO, or Controller Area Network (CAN) interface, depending on the deployment environment and required throughput. In embodiments, system communications bus 11115 supports multiplexed data channels configured to carry authenticated data streams, verification signals, and control instructions between modules while preserving data segregation and message integrity. The bus may include an addressable routing fabric with isolation registers and logic-level gating to prevent unauthorized access or data leakage between modules operating at different security classifications. In certain embodiments, system communications bus 11115 implements bus-level encryption or message authentication codes to preserve confidentiality and verify the origin of transmitted messages. In embodiments, the bus controller coordinates transmission arbitration, clock domain crossing, and error correction functions to maintain deterministic synchronization with clock and timing generator 11118 and to ensure reliable inter-module communication throughout system 11100.

In embodiments, the modular compliance verification and audit recording system 11100 comprises clock and timing generator 11118. Clock and timing generator, in embodiments, establishes synchronized timing signals used by processing and control module 11110, verification module 11160, and recording module 11150. In embodiments, clock and timing generator 11118 provides synchronized timing signals for coordinated operation among the modules of system 11100. Clock and timing generator 11118 establishes a unified time base for event sequencing, timestamp generation, and inter-module synchronization during compliance verification and audit recording. In embodiments, clock and timing generator 11118 includes a crystal oscillator, phase-locked loop (PLL), or voltage-controlled oscillator (VCO) to generate precision clock signals distributed through timing buses or synchronization lines within system 11100. The generator may interface directly with processing and control module 11110 to provide hardware-level interrupt timing and deterministic scheduling for compliance event handling. In certain embodiments, clock and timing generator 11118 supports network time synchronization protocols such as the Network Time Protocol (NTP) or Precision Time Protocol (PTP) to align system timestamps with external regulatory or enterprise audit servers. The module may also include redundant oscillators or watchdog timing logic configured to maintain synchronization integrity during transient power or communication faults. In embodiments, accurate timing coordination through clock and timing generator 11118 ensures consistent temporal ordering of authentication, verification, and recording operations, thereby supporting the generation of immutable, chronologically verifiable audit records within system 11100.

In embodiments, the modular compliance verification and audit recording system 11100 comprises initiation module 11120. Initiation module 11120, in embodiments, 11120 serves as the primary ingress point for compliance data entering system 11100. Initiation module 11120 is configured to receive incoming data streams from external electronic devices 11190 over network 11180 via secure gateway or proxy 11185 and to authenticate, validate, and register each compliance event before it is made available to downstream modules. In embodiments, initiation module 11120 includes a network interface controller (NIC) or input interface circuit implementing secure communication protocols such as Transport Layer Security (TLS), Secure Sockets Layer (SSL), or IPsec to protect inbound data channels. The module may also incorporate a hardware security module (HSM) or trusted platform module (TPM) configured to manage session keys, digital certificates, and cryptographic token validation used to confirm the authenticity of external devices 11190. In certain embodiments, initiation module 11120 performs checksum verification, digital signature validation, or hash-based integrity checks on received compliance data packets prior to registration. Once authenticated, initiation module 11120 generates an authenticated event stream containing verified data, source identifiers, and associated metadata such as timestamp and credential status, and transmits this stream through system communications bus 11115 for further processing by observation module 11125. In embodiments, initiation module 11120 may also perform rate-limiting, anomaly detection, or handshake synchronization to prevent data injection attacks or replay attempts during compliance event acquisition.

In embodiments, the modular compliance verification and audit recording system 11100 comprises observation module 11125. Observation module 11125, in embodiments, is configured to collect, generate, and structure operational evidence derived from authenticated event streams received from initiation module 11120 via system communications bus 11115. Observation module 11125 functions as an intermediary data aggregation and normalization layer, transforming authenticated data inputs into standardized observation data streams suitable for verification analysis. In embodiments, observation module 11125 includes one or more evidence capture interfaces that record transaction-level data, event timestamps, and system state information associated with each compliance event. The module may utilize high-resolution internal clocks synchronized with clock and timing generator 11118 to ensure precise temporal ordering of recorded events. Observation module 11125 may also maintain an event state cache or buffer memory configured to temporarily store captured evidence while verification module 11160 performs integrity and policy assessments. In certain embodiments, observation module 11125 employs hashing algorithms such as SHA-256 or SHA-3 to generate unique identifiers for each event record, thereby ensuring traceability and preventing data duplication. The module may additionally attach verification identifiers or cryptographic proofs to each observation record before transmitting an observation data stream to verification module 11160. In embodiments, observation module 11125 enforces strict data compartmentalization, allowing only authenticated, timestamped, and integrity-verified evidence to advance through system 11100, thereby maintaining evidentiary consistency and audit reliability across all downstream verification and recording operations.

In embodiments, a more detailed description of observation module 11125 is located in connection with the description of FIG. 15B. Referring to FIG. 15B, observation module 11125 may include several subcomponents configured to be operable to at least one of monitor, capture, and prepare operational evidence derived from authenticated event streams transmitted by initiation module 11120. The subcomponents of observation module 11125 are configured to collectively establish a structured mechanism for generating verifiable, time-correlated observation data streams for subsequent analysis and verification. For example, as illustrated in FIG. 15B, observation module 11125 may include evidence capture interface 11125a, event timestamping unit 11125b, and state cache 11125c.

In embodiments, evidence capture interface 11125a receives authenticated event streams from initiation module 11120 via system communications bus 11115 and extracts event-level data elements such as transaction identifiers, process states, and authentication metadata. Evidence capture interface 11125a may include one or more hardware-based network adapters, field-programmable gate arrays (FPGAs), or secure data acquisition controllers configured to receive serialized data packets representing compliance events. In embodiments, the interface may implement packet reassembly logic, checksum validation, and frame authentication to ensure the completeness and integrity of each received data segment. Evidence capture interface 11125a may further include parsing engines or structured data processors capable of transforming encoded or compressed data formats such as XML, JSON, or ASN.1 into normalized internal representations suitable for storage and downstream verification. The interface can apply data schema validation rules to confirm that incoming fields conform to a predefined compliance record structure, such as verifying that timestamps, credential tokens, and policy identifiers are properly formatted and associated with valid session metadata. In certain embodiments, evidence capture interface 11125a includes a hardware or firmware-based buffer configured with direct memory access (DMA) capability to stream event data directly into system memory 11140, reducing latency and minimizing processor overhead. The interface may also implement anomaly detection logic or pattern-recognition routines that identify corrupted packets, replay attempts, or malformed message headers before the event data proceeds to event timestamping unit 11125b.

In embodiments, event timestamping unit 11125b records precise temporal information associated with each event captured by evidence capture interface 11125a. Event timestamping unit 11125b operates in synchronization with clock and timing generator 11118 to maintain consistent and verifiable time correlation across all modules within system 11100. In embodiments, event timestamping unit 11125b may include a high-resolution oscillator, a hardware real-time clock (RTC), or a time-synchronization controller capable of nanosecond-level precision. The unit may implement synchronization protocols such as the Network Time Protocol (NTP), Precision Time Protocol (PTP), or Global Navigation Satellite System (GNSS)-based time sources to align system time with external authoritative references. Each timestamp generated by event timestamping unit 11125b may be embedded with a monotonic counter or sequence identifier to ensure non-repetition and detect anomalies caused by clock drift or reset conditions. In certain embodiments, the unit may also generate digital timestamp certificates using cryptographic signing functions, thereby associating each recorded event with a verifiable time attestation that can be independently validated during audit reconstruction. Event timestamping unit 11125b may further implement fault-detection mechanisms, such as cross-module clock comparison and drift compensation algorithms, to maintain temporal consistency even in distributed or intermittently connected environments. Through these functions, event timestamping unit 11125b ensures that each compliance event recorded within observation module 11125 is assigned an accurate, verifiable, and immutable time reference.

In embodiments, state cache 11125c maintains intermediate representations of operational states and contextual metadata associated with compliance events observed by evidence capture interface 11125a and timestamped by event timestamping unit 11125b. State cache 11125c may be implemented using volatile or semi-persistent memory technologies such as dynamic random-access memory (DRAM), non-volatile dual in-line memory modules (NVDIMMs), or high-speed solid-state cache partitions within system memory 11140. The cache temporarily stores data objects including event records, session identifiers, and partial verification flags while verification module 11160 performs policy and rule-set evaluation. In embodiments, state cache 11125c organizes stored information in indexed tables or key-value pairs that allow rapid retrieval based on identifiers such as timestamp, event type, or compliance policy reference. The cache may implement circular buffer or least-recently-used (LRU) management algorithms to optimize memory utilization and ensure that the most recent operational states remain available for correlation. In certain embodiments, state cache 11125c maintains multiple version instances of the same event record, allowing rollback or comparative evaluation of prior states during audit reconstruction or dispute resolution processes. The cache may further include integrity-check mechanisms such as hash verification or parity validation to detect unauthorized modifications or data corruption. State cache 11125c, in coordination with event timestamping unit 11125b, is configured to provide continuity and contextual traceability of compliance events within observation module 11125, enabled to ensure that each verified audit record reflects an accurate and temporally consistent operational state.

Referring back to FIG. 15A, in embodiments, the modular compliance verification and audit recording system 11100 comprises operator console module 11130. Operator console module 11130, provides an administrative and monitoring interface for authorized personnel to supervise the operation of system 11100. Operator console module 11130 is configured to display system states, verification results, and exception conditions generated during compliance data processing. In embodiments, operator console module 11130 includes a secure graphical user interface (GUI), command-line console, or web-based management interface operating over encrypted communication channels. The module may be implemented on a local terminal physically connected to system 11100 or on a remote workstation communicating through network 11180 via secure gateway 11185. Operator console module 11130 may include user authentication and session management logic such as multifactor verification, role-based access control (RBAC), or public key infrastructure (PKI) credentials to ensure that only authorized users can access administrative functions. In certain embodiments, operator console module 11130 interfaces directly with policy and privacy manager 11135 to allow configuration of data-classification rules, redaction parameters, and privacy policies. The module may further include a secure event viewer or audit dashboard that visualizes system logs, redaction logs, and verification states maintained within system memory 11140. In embodiments, operator console module 11130 operates as a read-controlled interface that enables oversight and diagnostics without permitting direct alteration of stored audit data, thereby preserving the immutability and evidentiary integrity of compliance records maintained within system 11100.

In embodiments, a more detailed description of policy and privacy manager 11135 is located in connection with the description of FIG. 15C. Referring to FIG. 15C, policy and privacy manager 11135 includes several subcomponents configured to enforce data protection, privacy preservation, and policy-driven information governance within modular compliance verification and audit recording system 11100. The illustrated configuration provides a layered privacy-control mechanism that operates between verification, recording, and communication functions to ensure that all transmitted audit data conform to applicable confidentiality and data-handling requirements. For example, as shown in FIG. 15C, policy and privacy manager 11135 includes data minimization filter 11135a, redaction engine 11135b, access control and consent manager 11135c.

In embodiments, data minimization filter 11135a evaluates audit records generated by recording module 11150 and selectively removes data elements classified as unnecessary, redundant, or sensitive. Data minimization filter 11135a may operate according to predefined privacy schemas or dynamically generated policy profiles stored in system memory 11140. The filter may perform field-level suppression or aggregation of personally identifiable information (PII), financial identifiers, or transaction-level details that are not required for regulatory validation. In embodiments, data minimization filter 11135a includes a policy evaluation engine implemented in software, firmware, or programmable logic configured to analyze metadata tags attached to each record, compare them against a privacy rule set, and execute appropriate filtering actions. The filter may also maintain a record of filtered fields in a private audit trail for traceability and post-processing review.

In embodiments, redaction engine 11135b applies masking, tokenization, or pseudonymization to data elements that must be retained for compliance purposes but cannot be transmitted in raw form. Redaction engine 11135b may include a secure transformation processor that replaces sensitive identifiers with reversible tokens or cryptographic surrogates linked to a protected key vault maintained within system memory 11140. In certain embodiments, redaction engine 11135b performs content-based redaction by analyzing contextual relationships within the audit record and obscuring data segments that could reveal individual identities or confidential operational parameters. The engine may support multiple redaction modes, including static templates, dynamic pattern recognition, or natural language filters, to adapt to diverse regulatory frameworks and data formats.

In embodiments, access control and consent manager 11135c manages user permissions, consent acknowledgments, and data-disclosure authorizations associated with outbound compliance information. In embodiments, access control and consent manager 11135c maintains an access matrix or authorization table stored in system memory 11140, mapping user or device identifiers to specific categories of data and permissible transmission endpoints. The manager may authenticate access requests using digital certificates, cryptographic tokens, or federated identity protocols such as OAuth or SAML. In certain embodiments, the manager also records consent artifacts and policy acknowledgments received from external entities to confirm authorization prior to releasing filtered or redacted audit data through communication module 11170. Access control and consent manager 11135c ensures that data transmission and disclosure activities performed by system 11100 remain compliant with relevant privacy regulations and user consent conditions.

In embodiments, the configuration illustrated in FIG. 15C is configured to enable policy and privacy manager 11135 to implement a comprehensive privacy-governance layer within the modular compliance verification and audit recording system 11100, combining data minimization, redaction, and access control functions to preserve confidentiality and regulatory conformity during audit data transmission.

Referring back to FIG. 15A, in embodiments, the modular compliance verification and audit recording system 11100 comprises policy and privacy manager 11135. Policy and privacy manager 11135, in embodiments, enforces privacy preservation and data-governance rules applied to compliance information within system 11100. Policy and privacy manager 11135 is configured to apply data-classification parameters, minimization filters, and redaction processes to audit records prior to external transmission. In embodiments, policy and privacy manager 11135 includes a data-minimization filter engine that evaluates audit data fields against predefined privacy schemas or regulatory profiles to remove nonessential or sensitive data elements. The module may also include a redaction engine that programmatically masks or tokenizes personally identifiable information (PII), financial identifiers, or proprietary content based on classification thresholds. Policy and privacy manager 11135 may be implemented as a software-based policy execution framework operating on dedicated processing resources or as a hardware-assisted subsystem incorporating secure enclaves or isolated memory partitions for handling sensitive data during transformation. In certain embodiments, policy and privacy manager 11135 communicates directly with system memory 11140 to access stored immutable audit records and applies privacy policies in real time as audit data transitions toward outbound transmission through communication module 11170. The module may also maintain a policy repository and redaction log that record all applied transformations, thereby providing verifiable evidence of privacy compliance. In embodiments, policy and privacy manager 11135 operates as a privacy-enforcing intermediary that is configured to ensure audit data released from system 11100 retains evidentiary value while satisfying applicable data-protection and confidentiality requirements.

In embodiments, the modular compliance verification and audit recording system 11100 comprises system memory 11140. System memory 11140, in embodiments, provides both volatile and non-volatile data storage resources for modular compliance verification and audit recording system 11100. System memory 11140 is configured to store operational data, rule sets, access-control profiles, and immutable audit records generated by recording module 11150 and accessed by policy and privacy manager 11135. In embodiments, system memory 11140 includes multiple addressable partitions or logical volumes, each associated with one or more modules of system 11100, to enforce compartmentalization of compliance data and prevent unauthorized inter-module access. The memory architecture may include random-access memory (RAM) for transient operational caching, non-volatile flash or solid-state storage for audit record retention, and a secure ledger partition configured to store cryptographically linked audit entries. In certain embodiments, system memory 11140 integrates a hardware security module (HSM), trusted execution environment (TEE), or secure enclave capable of performing on-chip encryption, key management, and cryptographic sealing of stored records. Each audit record may be associated with a unique hash or digital signature generated during the verification and recording process, enabling future validation of record authenticity and sequence integrity. In embodiments, system memory 11140 further includes error-correcting code (ECC) subsystems or redundancy protocols such as RAID or mirrored partitions to maintain data integrity in the event of physical faults or unauthorized modification attempts. System memory 11140 is configured to provide the secure data foundation for compliance verification, audit traceability, and privacy enforcement within system 11100.

In embodiments, a more detailed description of system memory 11140 is located in connection with the description of FIG. 15D. Referring to FIG. 15D, system memory 11140 includes multiple subcomponents configured to store, protect, and maintain compliance data, audit records, and cryptographic information within modular compliance verification and audit recording system 11100. The illustrated configuration provides a tiered memory architecture supporting both high-speed operational access and long-term secure retention of immutable audit data. For example, as shown in FIG. 15D, system memory 11140 includes secure non-volatile store 11140a, volatile memory 11140b, partitioned record store 11140c, encryption engine 11140d, key store or hardware security module (HSM) 11140e, and immutable audit ledger store 11140f.

In embodiments, secure non-volatile store 11140a retains persistent system data, including rule sets, access control profiles, and long-term audit archives. Secure non-volatile store 11140a may comprise solid-state drives, flash storage arrays, or write-once, read-many (WORM) memory devices configured to prevent unauthorized modification of stored records. The store may include integrated error correction logic and cryptographic hash validation for integrity verification during readback operations.

In embodiments, volatile memory 11140b provides temporary working storage for runtime processes executing within system 11100. Volatile memory 11140b may include dynamic random-access memory (DRAM) or synchronous DRAM modules, enabling high-speed buffering and caching of transient compliance data, event streams, and verification results. The volatile memory may be mapped to specific address spaces associated with individual modules to maintain data isolation between concurrent processes.

In embodiments, partitioned record store 11140c organizes stored audit data into logically separated partitions associated with specific compliance domains, users, or transaction types. Partitioned record store 11140c may employ an indexing scheme or hierarchical directory structure that facilitates rapid lookup, retrieval, and version tracking of audit records. Each partition may be configured with an individual access control policy and cryptographic key to prevent cross-domain data exposure.

In embodiments, encryption engine 11140d performs cryptographic operations required to secure stored data. Encryption engine 11140d may include dedicated hardware encryption processors or software-based cryptographic libraries configured to execute symmetric or asymmetric algorithms such as AES, RSA, or elliptic curve cryptography (ECC). The engine may encrypt both data at rest and in transit between memory regions, and may also perform integrity checks using message authentication codes or hash-based verification.

In embodiments, key store or hardware security module (HSM) 11140e manages the generation, storage, and protection of cryptographic keys used by encryption engine 11140d. In embodiments, key store or HSM 11140e comprises tamper-resistant hardware, isolated secure memory, or trusted execution environments (TEEs) configured to prevent unauthorized extraction of key material. The module may also implement key rotation, revocation, and multi-factor authorization processes to maintain ongoing cryptographic hygiene.

In embodiments, immutable audit ledger store 11140f maintains a sequential, append-only record of verified audit entries generated by recording module 11150. Immutable audit ledger store 11140f may employ hash-linked or blockchain-based data structures that mathematically bind each stored entry to its predecessor, creating an immutable record chain that enables independent verification of historical integrity. The ledger may periodically generate digest values or cryptographic checkpoints that can be validated externally for compliance certification.

In embodiments, the configuration illustrated in FIG. 15D is configured to enable system memory 11140 to provide a secure, partitioned, and cryptographically protected data environment within modular compliance verification and audit recording system 11100, supporting both operational performance and long-term audit integrity.

Referring back to FIG. 15A, in embodiments, the modular compliance verification and audit recording system 11100 comprises recording module 11150. Recording module 11150, in embodiments, is configured to generate, encrypt, and preserve immutable audit records within system memory 11140 based on verification results received from verification module 11160. Recording module 11150 receives verified compliance data streams and associated operational evidence through system communications bus 11115 and processes them into structured, tamper-evident audit entries. In embodiments, recording module 11150 implements secure-write logic or a ledger-based storage controller that links sequential audit entries using cryptographic hash chains or Merkle tree structures to ensure that any subsequent alteration of a stored record is mathematically detectable. The module may include a dedicated encryption engine employing symmetric or asymmetric cryptographic algorithms such as AES-256 or RSA to encrypt audit records prior to storage. In certain embodiments, recording module 11150 also embeds a digital signature or message authentication code (MAC) into each stored record, binding the verification result, operational evidence, and timestamp data into a unified and verifiable audit object. Recording module 11150 may further include a write-once, read-many (WORM) memory interface or append-only data structure to enforce immutability and prevent retroactive modification. In embodiments, the module periodically generates integrity validation reports or hash summaries of stored records for archival verification and replication to secondary storage environments. Through these mechanisms, recording module 11150 establishes a permanent, cryptographically verifiable audit history supporting end-to-end integrity assurance within system 11100.

Recording module 11150 is, in embodiments, configured to manage the creation, encryption, and secure preservation of immutable audit records derived from verified compliance data. In embodiments, a more detailed description of recording module 11150 is located in connection with the description of FIG. 15E. Referring to FIG. 15E, recording module 11150 includes subcomponents that perform sequential record generation, digital signing, and controlled write operations to ensure that stored audit entries cannot be modified or deleted after creation. The module coordinates directly with verification module 11160 and system memory 11140 to maintain cryptographically verifiable audit chains. For example, as shown in FIG. 15E, recording module 11150 includes secure-write controller 11150a and record verification signer 11150b.

In embodiments, secure-write controller 11150a governs the process of transforming verified compliance data into structured audit entries suitable for immutable storage. Secure-write controller 11150a may implement write-once, read-many (WORM) logic or append-only data structures that prevent retroactive modification. The controller may include a sequential index generator that assigns a unique identifier to each audit entry, ensuring traceability and chronological order. In certain embodiments, secure-write controller 11150a incorporates cryptographic hashing circuitry or checksum validation to detect anomalies or corruption during record generation. The controller may, in embodiments, manage data serialization, compression, and buffer flushing to optimize storage efficiency within system memory 11140.

In embodiments, record verification signer 11150b authenticates and seals each audit entry produced by secure-write controller 11150a. In embodiments, record verification signer 11150b generates a digital signature, message authentication code (MAC), or hash-based seal that cryptographically links each entry to its verification result and prior record, forming an immutable audit sequence. The signer may utilize asymmetric cryptographic algorithms and corresponding key material stored within key store or hardware security module 11140e. In some embodiments, record verification signer 11150b also generates a verification receipt or signature digest that can be exported for third-party audit validation. Record verification signer 11150b ensures that every stored record is traceable to a specific verification event and remains protected against unauthorized alteration.

In embodiments, the configuration illustrated in FIG. 15E is configured to enable recording module 11150 to generate, authenticate, and preserve immutable audit records within modular compliance verification and audit recording system 11100, ensuring verifiable audit continuity and data integrity.

Referring back to FIG. 15A, in embodiments, the modular compliance verification and audit recording system 11100 comprises verification module 11160. Verification module 11160, in embodiments, performs policy evaluation, access control enforcement, and integrity verification of observation data received from observation module 11125 through system communications bus 11115. Verification module 11160 applies stored rule sets and associated access control profiles to determine whether incoming compliance events conform to predefined operational or regulatory conditions. The module may include a rule processing engine or policy execution unit implemented through hardware logic, microcode, or software components executing on dedicated processors. The rule processing engine evaluates conditional expressions, compliance thresholds, or dependency rules defined by administrators through operator console module 11130. In some embodiments, verification module 11160 includes an access control validator that retrieves credential information or permission attributes from system memory 11140 to confirm that each data element being verified is authorized for access by the requesting module or external device. Verification module 11160 may also include an exception and escalation handler that identifies nonconforming or anomalous conditions and generates exception flags or alert signals to processing and control module 11110. When a compliance event satisfies its applicable rule set, verification module 11160 generates a verification signal representing a verified state and transmits the signal, along with associated metadata such as rule identifiers and evaluation timestamps, to recording module 11150 for immutable storage. Verification module 11160, based on the coordinated operations described above including policy evaluation, rule set application, access validation, and exception handling, is configured to ensure that only authenticated and policy compliant data are committed to the immutable audit record stored within system 11100.

Verification module 11160, in embodiments, is configured to govern rule evaluation, access validation, and integrity verification of compliance events processed within modular compliance verification and audit recording system 11100. In embodiments, a more detailed description of verification module 11160 is located in connection with the description of FIG. 15F. Referring to FIG. 15F, verification module 11160 includes subcomponents configured to retrieve verification policies, evaluate compliance conditions, and manage exception handling when operational events do not conform to stored rule sets. The verification module 11160, in embodiments, is configured to operate in coordination with observation module 11125, recording module 11150, and policy and privacy manager 11135 to ensure that all recorded audit data meet established compliance and authorization criteria. As an example, as shown in FIG. 15F, verification module 11160 includes rule set repository 11160a and exception and escalation handler 11160b.

In embodiments, rule set repository 11160a stores operational and regulatory policies used to evaluate compliance data received from observation module 11125. Rule set repository 11160a may include a relational or object-oriented database, a version-controlled rule engine, or a dedicated policy store maintained within system memory 11140. Each rule may define one or more logical conditions, thresholds, or dependencies associated with compliance verification. In certain embodiments, rule set repository 11160a supports dynamic updates, allowing administrators to modify or supplement active rule sets through operator console module 11130 without requiring system downtime. The rule set repository 11160a, in embodiments, may maintain metadata including rule version identifiers, applicable jurisdictions, and authorization signatures to ensure traceability and consistency of policy enforcement.

Exception and escalation handler 11160b, in embodiments, processes verification outcomes that fail to satisfy one or more conditions defined within rule set repository 11160a. Exception and escalation handler 11160b may include a rule evaluation monitor and a workflow engine configured to generate exception flags, log validation failures, or trigger corrective actions through processing and control module 11110. In embodiments, the exception and escalation handler 11160b classifies exceptions based on severity, regulatory impact, or data sensitivity and determines whether they require automatic resolution, manual review, or escalation to a higher-level verification process. Exception and escalation handler 11160b may generate structured reports or notification messages that are transmitted to operator console module 11130 for administrative visibility and remediation. The exception and escalation handler 11160b may record each exception event within system memory 11140, maintaining a permanent record of nonconformities for later audit reference.

In embodiments, the configuration illustrated in FIG. 15F is configured to enable verification module 11160 to execute policy-driven rule evaluation and controlled exception handling within modular compliance verification and audit recording system 11100, ensuring that only validated and authorized data are preserved within immutable audit records.

Referring back to FIG. 15A, in embodiments, the modular compliance verification and audit recording system 11100 further comprises communication module 11170. Communication module 11170, in embodiments, manages outbound transmission of compliance information that has been filtered and redacted by policy and privacy manager 11135. Communication module 11170 receives the filtered and redacted output through system communications bus 11115 and prepares it for delivery to external electronic devices 11190 over network 11180 via secure gateway or proxy 11185. The module may include one or more network interface controllers, protocol encoders, or transmission processors configured to construct outbound data packets containing privacy protected audit information, routing metadata, and authentication credentials. In embodiments, communication module 11170 supports secure transmission protocols such as HTTPS, TLS, or IPsec to maintain confidentiality and integrity of outbound compliance data. The module may include message authentication or digital signing functions that attach verification certificates or integrity hashes to each outbound packet. Communication module 11170 can also perform transmission queueing, retry handling, and rate control to ensure reliable delivery under variable network conditions. In certain embodiments, the module interfaces with processing and control module 11110 to record transmission events and confirm receipt acknowledgments from external devices 11190. Communication module 11170, operating in coordination with secure gateway 11185, provides the final transfer stage of system 11100 by ensuring that all outbound audit information is transmitted through authenticated, encrypted channels that preserve data integrity and privacy compliance.

In embodiments, communication module 11170 is configured to manage the outbound exchange of privacy-protected compliance data between modular compliance verification and audit recording system 11100 and external electronic devices 11190. In embodiments, a more detailed description of communication module 11170 is located in connection with the description of FIG. 15G. Referring to FIG. 15G, communication module 11170 includes multiple subcomponents configured to perform packet routing, message validation, timing alignment, and transmission integrity monitoring. The module interacts with policy and privacy manager 11135 to receive filtered and redacted audit outputs and prepares them for network delivery through secure gateway 11185. For example, as shown in FIG. 15G, communication module 11170 includes routing and compartmentalization logic 11170a, message authentication and validation unit 11170b, time synchronization module 11170c, and health and integrity monitor 11170d.

In embodiments, routing and compartmentalization logic 11170a governs the transmission path and data segregation of outbound audit packets. Routing and compartmentalization logic 11170a may implement packet routing tables, priority-based transmission queues, and channel compartmentalization rules that separate audit data according to classification level, destination endpoint, or jurisdictional requirements. In certain embodiments, the logic applies dynamic routing decisions based on network load, latency conditions, or security policy, ensuring reliable and compliant data transmission through network 11180. Routing and compartmentalization logic 11170a may enforce boundary isolation between concurrent outbound sessions to prevent data crossover, metadata leakage between unrelated compliance domains, or a combination thereof.

Message authentication and validation unit 11170b, in embodiments, is configured to confirm the authenticity and integrity of all outbound transmissions prior to release through secure gateway 11185. In embodiments, message authentication and validation unit 11170b performs cryptographic hashing, digital signature verification, or message authentication code (MAC) generation using key material stored within key store or HSM 11140e. The unit may attach authentication headers or certificates to outbound packets and validate acknowledgments returned from external electronic devices 11190. Message authentication and validation unit 11170b provides end-to-end assurance that audit information transmitted from system 11100 has not been altered or intercepted during transit.

Time synchronization module 11170c maintains coordinated timing alignment between communication module 11170, clock and timing generator 11118, and external network endpoints. Time synchronization module 11170c may implement protocols such as Precision Time Protocol (PTP) or Network Time Protocol (NTP) to ensure consistent timestamping of outbound transmissions. In certain embodiments, the module compensates for latency, jitter, or network-induced delay to preserve chronological accuracy of transmitted audit events. Time synchronization module 11170c enables external verification systems to correlate received audit records with their original event times, maintaining traceability throughout distributed audit networks.

Health and integrity monitor 11170d continuously evaluates the operational status and performance of communication module 11170. Health and integrity monitor 11170d may collect diagnostic data including transmission success rates, packet loss metrics, and authentication failure counts. The monitor can initiate self-tests or recovery operations in response to detected anomalies, such as transmission errors or encryption failures. In embodiments, health and integrity monitor 11170d reports its findings to processing and control module 11110 for inclusion in system-wide health assessments and compliance readiness reports.

In embodiments, the configuration illustrated in FIG. 15G is configured to enable communication module 11170 to perform secure, authenticated, and time-synchronized data transmission within modular compliance verification and audit recording system 11100, maintaining integrity and reliability of audit information exchanged with external electronic devices 11190.

In embodiments, network 11180 provides the communication infrastructure through which modular compliance verification and audit recording system 11100 exchanges data with external electronic devices 11190. Network 11180 may include one or more interconnected communication layers, such as a local area network, wide area network, or cloud-based enterprise network, configured to support secure data transport between distributed system components. In embodiments, network 11180 may operate through wired communication links such as Ethernet, fiber optic, or serial interfaces, wireless connections such as Wi-Fi, cellular, or satellite links, or a combination thereof, depending on the deployment environment. Network 11180 supports bi-directional communication between system 11100 and external electronic devices 11190, enabling both the receipt of incoming compliance data streams and the transmission of filtered or redacted audit information. The network may operate using packet switched communication protocols such as TCP/IP and may incorporate virtual private network (VPN) tunnels or dedicated communication links to isolate compliance traffic from general network operations. Network 11180 can include routers, switches, and firewalls configured with predefined access control lists to prevent unauthorized connections or unverified data ingress. In certain embodiments, network 11180 supports redundancy and fault tolerance through multi path routing or load balancing mechanisms to maintain operational continuity during transmission failures or high demand conditions. Network 11180 provides the physical and logical pathway through which secure gateway 11185 manages authenticated communication between modular compliance verification and audit recording system 11100 and external electronic devices 11190.

In embodiments, secure gateway or proxy 11185 establishes a controlled and authenticated interface between modular compliance verification and audit recording system 11100 and network 11180. Secure gateway 11185 manages both inbound and outbound transmissions between system 11100 and external electronic devices 11190, enforcing encryption, authentication, and content validation at the network boundary. The gateway operates as a security intermediary, preventing unauthorized network access and mitigating potential threats such as injection attacks or replay of compliance data packets. In embodiments, secure gateway 11185 includes encryption and decryption engines, key management circuitry, and network interface components capable of performing high speed cryptographic operations. The gateway may implement protocols such as Transport Layer Security (TLS), Internet Protocol Security (IPsec), or Secure Shell (SSH) to maintain confidentiality and data integrity during communication sessions. In certain embodiments, secure gateway 11185 functions as a reverse proxy or firewall appliance that authenticates external devices 11190 using digital certificates, session keys, or token-based credentials before permitting compliance data to enter or leave system 11100. The gateway may also perform packet inspection, address translation, and anomaly detection to identify or block unauthorized traffic. By maintaining encrypted tunnels and authenticated network sessions, secure gateway 11185 ensures that all communications between system 11100 and external electronic devices 11190 over network 11180 occur through verified, integrity-protected channels.

In embodiments, external electronic devices 11190 represent one or more external systems, terminals, or computational platforms that exchange compliance-related data with modular compliance verification and audit recording system 11100 over network 11180 through secure gateway 11185. External electronic devices 11190 may include servers, desktop computers, portable computing systems, embedded controllers, or dedicated compliance management platforms operated by external organizations or regulatory entities. Each external electronic device 11190 may include one or more input devices 11194 and output devices 11196 that facilitate the transmission and reception of compliance data sets 11192, compliance data, audit results, and control messages. Input devices 11194 may include data entry terminals, network sensors, or system log collectors configured to generate or relay compliance event data to initiation module 11120. Output devices 11196 may include display terminals, reporting interfaces, or archival storage systems configured to receive filtered or redacted audit information from communication module 11170. In embodiments, external electronic devices 11190 may transmit structured compliance datasets, authentication credentials, or event logs for verification, or receive corresponding verification results and immutable audit confirmations generated by system 11100. Multiple external electronic devices 11190 can communicate with system 11100 simultaneously through segregated encrypted channels managed by secure gateway 11185, allowing distributed compliance operations across enterprise or multi-tenant environments. External electronic devices 11190, together with their associated input and output interfaces, serve as both the source and destination for compliance information exchanged within the operational framework of system 11100.

In embodiments, external electronic devices 11190 represent one or more remote or distributed computing systems that exchange compliance-related information with modular compliance verification and audit recording system 11100 over network 11180 through secure gateway 11185. External electronic devices 11190 may include servers, desktop workstations, portable computers, mobile terminals, or dedicated compliance management platforms operated by external entities, regulators, or enterprise users. Each device may function as a data source, a data destination, or both, depending on whether it originates or receives compliance information. Multiple external electronic devices 11190 can communicate with system 11100 simultaneously through segregated encrypted communication channels maintained by secure gateway 11185, enabling concurrent multi-tenant operation and distributed compliance oversight.

In embodiments, each external electronic device 11190 may include one or more input devices 11194 and output devices 11196. Input devices 11194 may include keyboards, scanners, network sensors, log collectors, biometric readers, or machine-to-machine data interfaces configured to generate or forward compliance event data to initiation module 11120. Output devices 11196 may include display terminals, reporting consoles, or secure storage interfaces that receive audit confirmations, verification results, or redacted reports transmitted from communication module 11170. Input devices 11194 and output devices 11196 may be integrated into the same electronic device or distributed across different subsystems operating under a unified identity credential. In embodiments, each input or output device supports encrypted communication protocols and may include local caching or buffering capabilities for staging data prior to transmission or after receipt of verified audit information.

External electronic devices 11190 exchange multiple categories of information with system 11100, including compliance datasets 11192, raw compliance data, audit results, and control messages. Compliance datasets 11192 may comprise structured or semi-structured collections of regulatory data such as transaction records, system logs, configuration baselines, access control events, and policy declarations generated within an enterprise environment. Each dataset may include data fields identifying a user or system entity, a timestamp, a digital signature or cryptographic hash, a policy identifier, and contextual metadata defining the scope of the compliance event. Audit results transmitted from communication module 11170 may include verification state indicators, immutable record identifiers, and exception notifications associated with previously submitted compliance events. Control messages exchanged between system 11100 and external electronic devices 11190 may include authentication handshakes, session management commands, acknowledgment packets, and policy updates that synchronize external device configurations with active rule sets maintained within system 11100. Through these bidirectional data exchanges, external electronic devices 11190 operate as the external interface layer for the transmission and reception of compliance datasets 11192, enabling continuous verification and privacy-preserving audit interaction with modular compliance verification and audit recording system 11100.

In embodiments, modular compliance verification and audit recording system 11100 is operable to enable authenticated, policy-controlled, and privacy-preserving handling of compliance data from ingestion through transmission. The system coordinates the functions of initiation module 11120, observation module 11125, verification module 11160, recording module 11150, policy and privacy manager 11135, and communication module 11170 through processing and control module 11110 and system communications bus 11115. Incoming compliance information from external electronic devices 11190 is authenticated, verified, recorded, and transmitted within a secure framework that enforces data integrity and confidentiality at each stage of processing. The architecture illustrated in FIG. 15A provides the foundational hardware and communication structure for implementing these coordinated operations. A more detailed description of the functionality of modular compliance verification and audit recording system 11100 is provided below in connection with FIG. 15H.

Referring to FIG. 15H, modular compliance verification and audit recording system 11100 is illustrated in a configuration that depicts the end-to-end movement of compliance data between external electronic devices 11190 and the internal modules of system 11100. In embodiments, external electronic devices 11190 provide an incoming compliance data stream 11190a originating from one or more input devices 11194. The incoming compliance data stream 11190a traverses network 11180 and enters secure gateway or proxy 11185 through a first encrypted ingress channel 11185a-1. Secure gateway 11185 authenticates, decrypts, and validates the transmission before forwarding the data to system 11100 through a first secure egress channel 11185b-1.

Within system 11100, initiation module 11120 receives incoming compliance data stream 11190a via first secure egress channel 11185b-1 and performs authentication operations to generate an authenticated event stream 11120a. Authenticated event stream 11120a includes verified compliance event data, a source identifier corresponding to the transmitting external electronic device 11190, and authentication metadata including timestamps, credential validity, and integrity status. Initiation module 11120 registers each authenticated event and transmits authenticated event stream 11120a to observation module 11125 through system communications bus 11115.

Observation module 11125 processes authenticated event stream 11120a to generate operational evidence such as event logs, transactional records, and synchronized timestamps, forming an observation data stream 11125a. Observation data stream 11125a includes contextual information required for subsequent rule evaluation and a verification identifier for correlation during downstream processing. Observation module 11125 transmits observation data stream 11125a to verification module 11160 via system communications bus 11115.

Verification module 11160 accesses stored rule sets and associated access-control profiles from system memory 11140 and applies those rule sets to observation data stream 11125a to determine whether the received data satisfy predefined operational or regulatory conditions. Based on that determination, verification module 11160 generates a verification signal 11160a that identifies each event as either a verified state or an exception condition. Verification module 11160 appends rule identifiers and evaluation timestamps to verification signal 11160a and transmits it to recording module 11150.

Recording module 11150 receives verification signal 11160a and constructs an immutable audit record signal 11150a that combines the verification results with the operational evidence generated by observation module 11125. Recording module 11150 then creates an encrypted, immutable audit entry stored within system memory 11140 to preserve evidentiary completeness and chronological order. The resulting immutable audit record signal 11150a is forwarded to policy and privacy manager 11135 for privacy and policy enforcement.

Policy and privacy manager 11135 applies data-minimization filters and redaction rules to immutable audit record signal 11150a in accordance with active privacy policies. The processing produces a filtered and redacted output 11135a containing privacy-protected audit information in which personal or financial identifiers have been removed or masked while preserving evidentiary structure.

Policy and privacy manager 11135 transmits filtered and redacted output 11135a to communication module 11170 for network delivery.

Communication module 11170 constructs an outbound transmission 11170a that packages filtered and redacted output 11135a together with routing metadata, authentication material, and integrity verification data. Outbound transmission 11170a is transmitted from communication module 11170 to secure gateway or proxy 11185 through a second secure egress channel 11185b-2. Secure gateway 11185 encrypts and authenticates the outgoing traffic before sending it through network 11180 via a second encrypted ingress channel 11185a-2 to external electronic devices 11190. External electronic devices 11190 receive the transmission as a verified audit data stream 11190b, which may be displayed, logged, or processed by one or more output devices 11196.

In embodiments, the bidirectional configuration of FIG. 15H enables system 11100 to receive continuous streams of compliance evidence from input devices 11194 while simultaneously transmitting verified, privacy-protected audit results to output devices 11196. The labeled flows 11190a, 11120a, 11125a, 11160a, 11150a, 11135a, 11170a, and 11190b illustrate sequential transformation stages that maintain authenticity, integrity, and privacy of the compliance information as it traverses system 11100. The secure channels 11185a-1, 11185b-1, 11185a-2, and 11185b-2 define gateway-mediated trust boundaries that protect data confidentiality and ensure that every transmission across network 11180 remains verifiable and tamper-resistant.

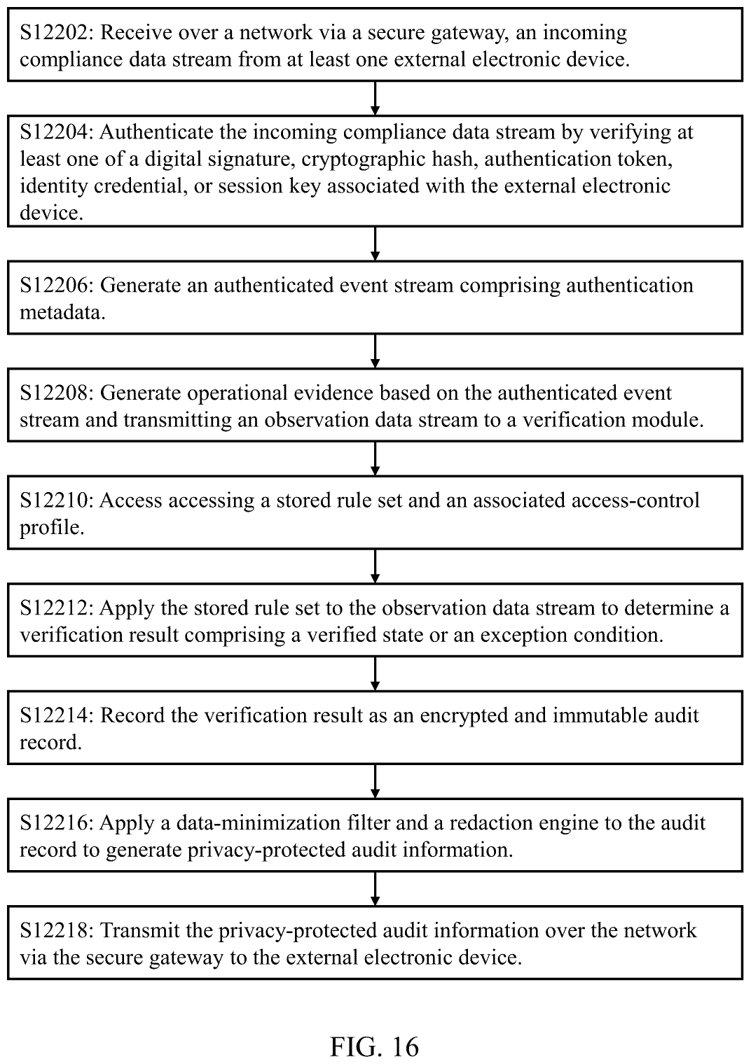

The process of FIG. 16, in embodiments, may begin with step S12202 of FIG. 16. Referring to FIG. 16, at step S12202, modular compliance verification and audit recording system 11100 receives, over network 11180 via secure gateway or proxy 11185, an incoming compliance data stream 11190a from at least one external electronic device 11190. In embodiments, incoming compliance data stream 11190a may originate from one or more input devices 11194 associated with external electronic device 11190 and may include compliance event data, user identifiers, contextual metadata, and transmission credentials. Secure gateway or proxy 11185 decrypts and validates the incoming compliance data stream 11190a to ensure proper session establishment before delivering it to initiation module 11120 through system communications bus 11115.

In embodiments, the process of FIG. 16 may continue with step S12204. At step S12204, initiation module 11120 authenticates the incoming compliance data stream 11190a by verifying at least one of a digital signature, cryptographic hash, authentication token, identity credential, or session key associated with the transmitting external electronic device 11190. The authentication process may include verifying cryptographic checksums for data integrity, evaluating digital certificates issued by trusted authorities, or validating active session tokens issued by system 11100 during prior exchanges. If one or more authentication parameters fail validation, initiation module 11120 may generate an exception message or alert signal to processing and control module 11110 for audit and quarantine operations.

In embodiments, the process of FIG. 16 may continue with step S12206. At step S12206, in embodiments, initiation module 11120 generates an authenticated event stream 11120a based on the verified compliance data. Authenticated event stream 11120a may include the authenticated payload, timestamp, verified device identifier, and authentication metadata indicating credential validity and message integrity. This event stream provides a trusted baseline for all downstream compliance processing. The authenticated event stream 11120a is then transmitted via system communications bus 11115 to observation module 11125 for evidence generation.

In embodiments, the process of FIG. 16 may continue with step S12208. At step S12208, observation module 11125 generates operational evidence based on authenticated event stream 11120a. In embodiments, the operational evidence may include transaction records, event logs, configuration snapshots, and time-correlated data reflecting system or user behavior. Observation module 11125 compiles these elements into an observation data stream 11125a that contains structured records of the compliance event and an associated verification identifier for traceability. Observation module 11125 then transmits observation data stream 11125a to verification module 11160 via system communications bus 11115.

In embodiments, the process of FIG. 16 may continue with step S12210. In embodiments, at step S12210, verification module 11160 accesses a stored rule set and an associated access-control profile from system memory 11140. The rule set may define compliance criteria, policy requirements, or operational thresholds used to determine event validity, while the access-control profile governs module or user permissions for evaluating particular categories of data. Verification module 11160 retrieves these resources through controlled access calls that validate credential authenticity before processing begins.

In embodiments, the process of FIG. 16 may continue with step S12212. At step S12212, verification module 11160 applies the stored rule set to observation data stream 11125a to determine a verification result. In embodiments, this involves comparing operational evidence against predefined conditions, such as adherence to security policies, system configuration baselines, or timing constraints. Verification module 11160 generates a verification signal 11160a that represents the result, classifying each event as either a verified state or an exception condition. Exception conditions may trigger escalation or notification procedures handled by processing and control module 11110. The verification signal 11160a is transmitted to recording module 11150 for archival processing.

In embodiments, the process of FIG. 16 may continue with step S12214. In embodiments, at step S12214, recording module 11150 receives verification signal 11160a and records the verification result as an encrypted and immutable audit record. The module constructs immutable audit record signal 11150a comprising the verification result, operational evidence, and temporal metadata. Recording module 11150 applies cryptographic sealing or blockchain-style hash chaining to preserve record integrity and prevent post-write modification. The resulting audit record is stored within system memory 11140 for long-term retention and verifiability.

In embodiments, the process of FIG. 16 may continue with step S12216. At step S12216, policy and privacy manager 11135 applies a data-minimization filter and redaction engine to the immutable audit record to generate privacy-protected audit information. In embodiments, the data-minimization filter removes nonessential or sensitive data fields such as personal identifiers or financial account details, while the redaction engine masks portions of the audit record that could reveal confidential attributes. Policy and privacy manager 11135 generates filtered and redacted output 11135a representing the privacy-protected audit record suitable for network transmission.

In embodiments, the process of FIG. 16 may continue with step S12218. At step S12218, communication module 11170 transmits the privacy-protected audit information over network 11180 via secure gateway or proxy 11185 to external electronic device 11190. In embodiments, communication module 11170 packages filtered and redacted output 11135a into an outbound transmission 11170a that includes routing metadata, authentication credentials, and digital integrity checks. Secure gateway 11185 encrypts and authenticates the outbound transmission before forwarding it through network 11180, where it is received as verified audit data stream 11190b by output device 11196 of external electronic device 11190. The process thereby completes a full compliance verification cycle, maintaining authenticity, integrity, and privacy of the underlying data throughout each operational stage.

In embodiments, the steps of the process described above in connection with FIG. 16 may be rearranged, repeated, or omitted without departing from the scope of the invention. Certain steps, such as authentication, verification, or privacy filtering, may be performed in parallel or iteratively based on network configuration, system load, or policy requirements.

Shown throughout the figures, the present invention is directed toward a system and method for implementing and executing machine learning in performing governance, risk management and compliance assessment. As such, users (e.g., compliance officers or enterprises) may define, submit, deploy, manage, retain, and execute their GRC platform and related content in a fully transparent and secure fashion. That is, the disclosed embodiments provide a GRC technology solution to active documents that are continuously updated and produces cybersecurity audit documentation and compliance assessments, recommendations and reports. Thus, the system and method herein manages, stores, updates, and curates pertinent regulatory codes, requirements, laws and incidental documentaries and advises on their use and impacts of ignoring such in the context of performing governance, risk management and compliance assessment. Importantly, the system and method of the disclosed embodiments

provide an advantageous improvement of practical applications including, but not limited to, governance, risk management and compliance assessment and management systems, machine learning systems, and document management system. This solves GRC-centric problems related to document creation, document retention, and risk assessment while providing for an enhanced vehicle to manage, assess and improve overall compliance (e.g., an enterprise-wide assessment). For example, the system and method of the disclosed embodiments may be employed for cybersecurity assessments and evaluations, audit and compliance assessments associated with FedRAMP, PCI DSS, HIPAA, Sarbanes Oxley, ISO 27001 SSAE 16 and other such existing assessment standards promulgated, risk management assessment associated with ISO 27005, NIST special publications and other such existing promulgated publications, and governance and policy development. The disclosed embodiments facilitate analyzing various data sets using machine learning models for descriptive, predictive, and prescriptive purposes in improving audit, compliance, and cybersecurity outcomes. That is, the present invention will assist in using and assessing GRC data to explain what has happened (i.e., descriptive), predict what will happen (i.e., predictive), and make suggestions about what action(s) to take (i.e., prescriptive).

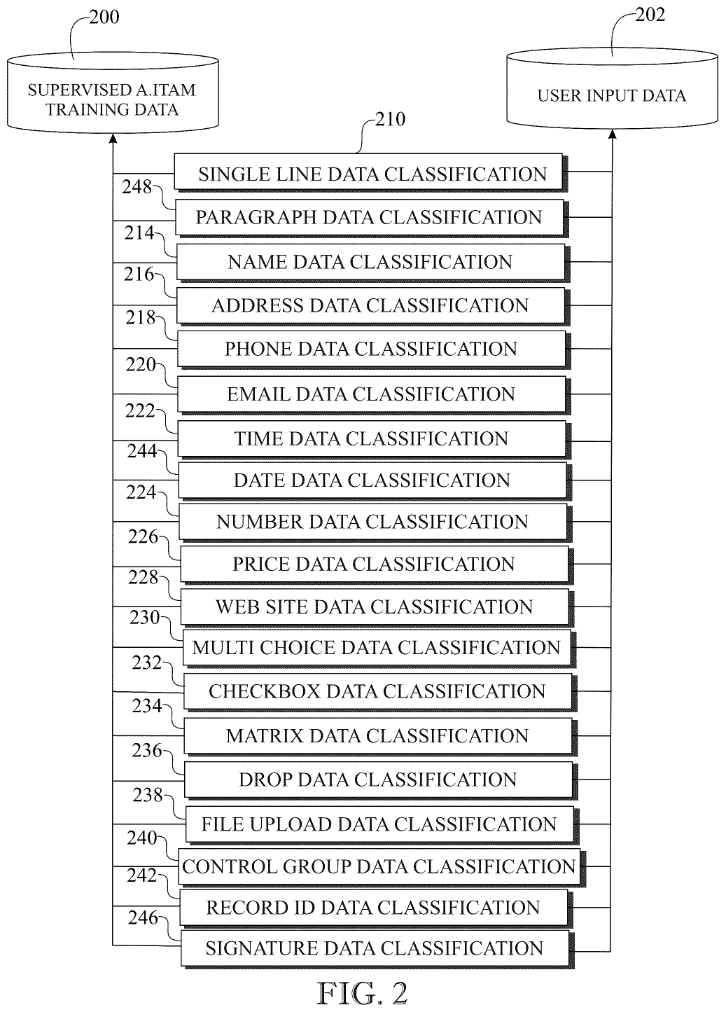

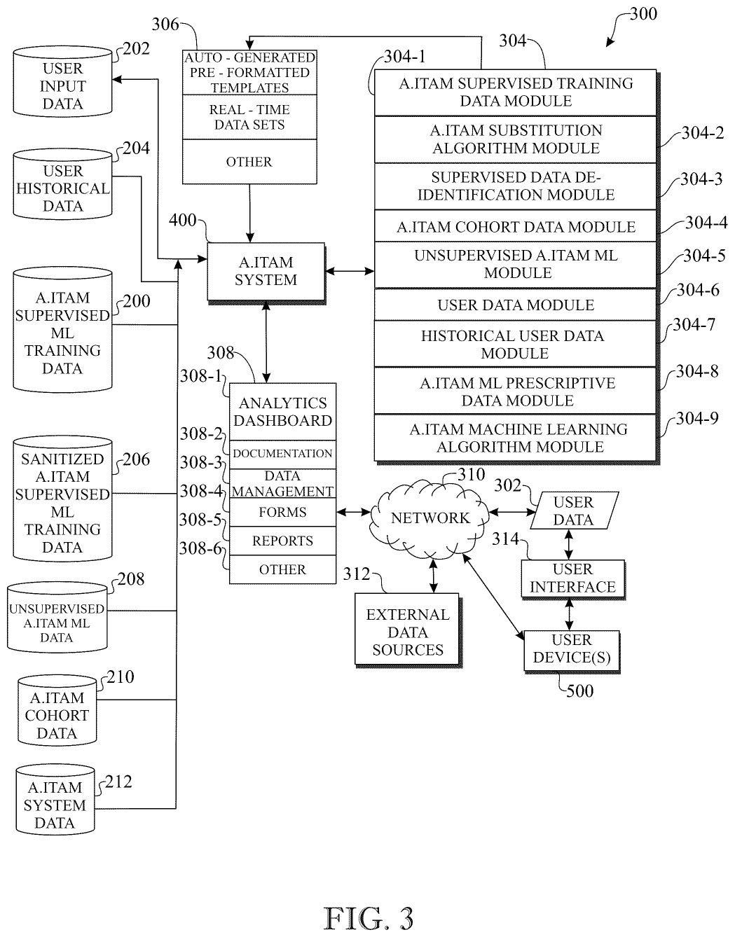

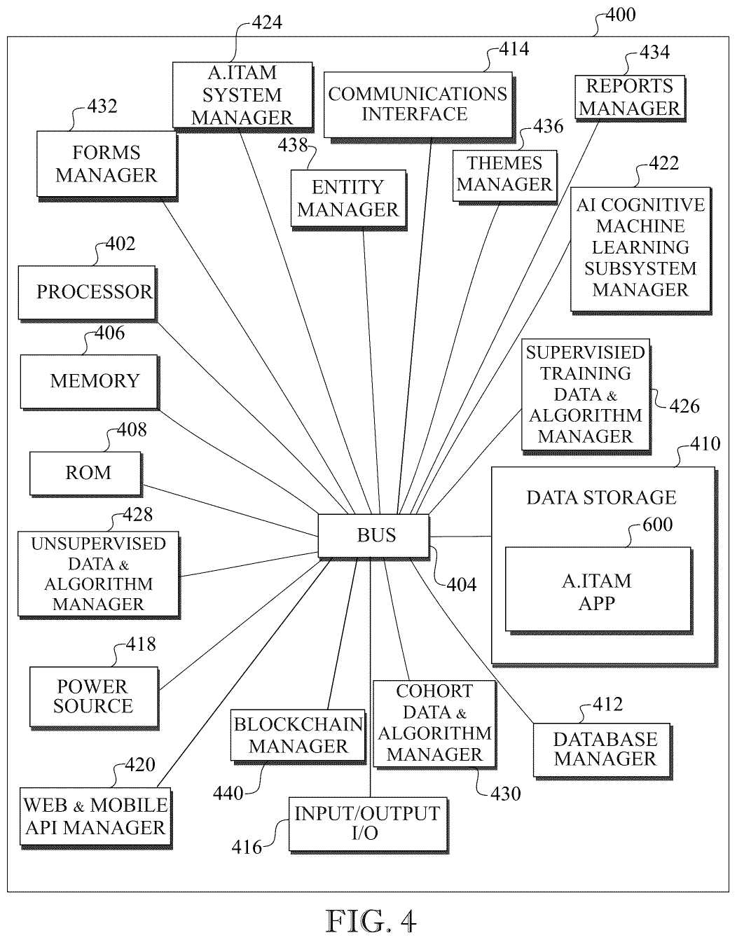

Turning our attention to FIGS. 1, 2 and 3, which will now be discussed together, a flowchart of illustrative operations 100 are presented in FIG. 1 for applying machine learning in performing governance, risk management and compliance assessment in accordance with an embodiment. FIG. 2 presents a schematic of labeled data sets for use in defining supervised training data and user input data that are used for model training in accordance with an embodiment, and FIG. 3 presents a high-level block diagram of a cloud network services architecture 300 for providing governance, risk management and compliance assessment in accordance with an embodiment. More particularly, at step 102, receive supervised artificial intelligence (AI) technology audit machine training data. The A.ITAM system 400 (see, e.g., FIGS. 3 and 4) communicates with multiple user interfaces 314 in exchanging various data and data sets such as user data 316 received from user device(s) 500 and/or other external data sources 312 (e.g., a governmental agency). Depending upon the context herein, users are individuals who are using the A.ITAM system 400 and entering in data for their GRC programs, examiners are individuals that oversee particular entities and achieving their GRC goals, and administrators are individuals that are charged with administration of the A.ITAM system 400.

Illustratively, communications occur using network 310 that may comprise a plurality of servers, access points and databases in the operation and execution of cloud computing environments. Communication links 302 provide either wired or wireless communications links in accordance with any number of well-known communications protocols. Illustratively, there is receiving a plurality of labeled data sets that are associated with a particular one form of a plurality of forms, wherein each labeled data set is associated with one or more field types and the labeled data is used to classify data or predict a particular outcome. In turn, producing a training data set comprising (a) a plurality of inputs from the one or more field types of the labeled data set associated therewith and (b) one or more correction outputs derived by applying a substitution model, at steps 104 and 106, that removes personally identifiable information, proprietary information, and identified sensitive data and substituting predetermined information therefore. Thus, a substitution model is employed as a sanitization of the one or more correction outputs derived by applying a substitution model that removes personally identifiable information, proprietary information, and identified sensitive data and substituting predetermined information therefore, and applying a supervisory training model for iteratively learning using the training data set produced and outputting a supervised training data set. The removal of such information increases the personal security of the data and ensures the risk of data breaches (e.g., identity theft) is significantly reduced. At step 108, the sanitized supervised A.ITAM ML training data is stored in sanitized supervised A.ITAM ML training database 206. The supervised data A.ITAM training database 200 stores such supervised data sets allows for applying a supervisory training model for iteratively learning using the training data set produced and outputting a supervised training data set. As noted previously, labeled data sets play an important role in the various operations. In accordance with the disclosed embodiments, forms using one or more field types are defined using data entry fields comprised by simple data fields and complex data fields. Simple data fields include but are not limited to: single line field 210, name field 214, phone field 218, electronic mail field 220, time field 222, data field 244, number field 224, price field 226, website field 228, file upload 238, signature data field 246 and paragraph field 248. Complex data fields include but are not limited to: address field 216, checkbox field 232, multiple choice field 230, matrix field 234, dropdown field 236, and record field 242. These data fields are used with respect to at least the supervised A.ITAM training data 200 and the user input data 202. These various form field options will now be described in further detail:

### Single Line Text

This field comprises a single line of text information the user wants to acquire from the respondent in the user's form. A single field will accept up to 65,535 characters or about 18 full pages of text.

Expanding the field properties will present these options:
Field Label: Field Label is one or two words placed directly above the field.
Field Type: Field Type determines what kind of data can be collected by the field. After the user saves the form, the field type cannot be changed.
Field Size: Checking this rule will make sure that a user fills out a particular field. A message will be displayed to the user if they have not filled out the field.
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters.
Admin Only: By setting this value, the field will be pre-populated with the text the user enters.
Display as a Password Field: Checking this will display the field as a password field and mask all the characters (shown as asterisks or circles). There is no encryption being made for the password field. The user will be able to see it from the admin panel/email as a plain text.
Limit By Words or Characters: The user can limit the amount of characters typed to be between certain characters or words, or between certain values in the case of number field. Leave the value blank or 0 if the user does not want to set any limit.
Default Value: By setting this value, the field will be pre-populated with the text the user enters.
Guidelines for User: This is an advanced option. The user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Enable Status Indicator: This is a great visual indicator of progress that helps to inform everyone what the status is in real time of the multitude of form fields, inputs and controls.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. The user can add a custom Policy Machine variable to the parent element of the field. This is useful if the user would like to generate Policy Machine reports using A.ITAM form data. These custom Policy Machine codes will not appear live in the form builder, only on the live form.

### Paragraph Text

This field facilitates a paragraph of rich text information the user wants to acquire from the respondent in the user's form. A single field will accept up to 65,535 characters or about 18 full pages of text.

Expanding the field properties will present these options:
Field Label: Field Label is one or two words placed directly above the field.
Field Type: Field Type determines what kind of data can be collected by the user's field. After the user save the form, the field type cannot be changed.
Field Size: Checking this rule will make sure that a user fills out a particular field. A message will be displayed to the user if they have not filled out the field.
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters.
Admin Only: By setting this value, the field will be pre-populated with the text the user enters.
Limit By Words or Characters: the user can limit the number of characters typed to be between certain characters or words, or between certain values in the case of number field. Leave the value blank or 0 if the user does not want to set any limit.
Default Value: By setting this value, the field will be pre-populated with the text the user enters.
Guidelines for User: This is an advanced option. the user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Enable Status Indicator: This is a great visual indicator of progress that helps to inform everyone what the status is in real time of the multitude of form fields, inputs and controls.
Enable Rich Text: Another great attribute of the Paragraph field element is in its rich text input from users of the user's form modules. Enabling it is as simple as selecting the option.
Custom CSS Class: This is an advanced option. the user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. the user can add a custom Policy Machine variable to the parent element of the field. This is useful if the user would like to generate Policy Machine reports using A.ITAM form data. These custom Policy Machine codes will not appear live in the form builder, only on the live form.

### Name

This field facilitates the ability to collect information about a person's name and title.

Expanding the field properties will present these options:
Field Label: Field Label is one or two words placed directly above the field.
Field Type: Field Type determines what kind of data can be collected by your field. After the user save the form, the field type cannot be changed.
Name Format:
   Title (This is the second and fourth enhanced setting)
   First (This is the default setting)
   Middle (This is the third and fourth enhanced setting)
   Last (This is the default setting)
   Suffix (This is the second and fourth enhanced setting)
Required: Checking this rule will make sure that a user fills out a particular field. A message will be displayed to the user if they have not filled out the field.
Everyone: By setting this value, the field will be pre-populated with the text the user enters.
Admin Only: By setting this value, the field will be pre-populated with the text the user enters.
Guidelines for User: This is an advanced option. the user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Custom CSS Class: This is an advanced option. the user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. the user can add a custom Policy Machine variable to the parent element of the field. This is useful if the user would like to generate Policy Machine reports using A.ITAM form data. These custom Policy Machine codes will not appear live in the form builder, only on the live form.

### Address

This field allows a user to include the collection of address information. Any country or city in the world may be selected as a default option.

### Phone

This field is a great choice when the user wants to collect telephone number information from the user's respondent.

Expanding the field properties will present these options:
Field Label: Field Label is one or two words placed directly above the field.
Field Type: Field Type determines what kind of data can be collected by the user's field. After the user save the form, the field type cannot be changed.
Phone Format: United States domestic formatting and international formatting
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters
Admin Only: By setting this value, the field will be pre-populated with the text the user enters.
Limit By Words or Characters: the user can limit the number of characters typed to be between certain characters or words, or between certain values in the case of number field. Leave the value blank or 0 if the user does not want to set any limit.
Default Value: By setting this value, the field will be pre-populated with the text the user enters.
Guidelines for User: This is an advanced option. the user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Custom CSS Class: This is an advanced option. the user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. the user can add a custom Policy Machine variable to the parent element of the field. This is useful if the user would like to generate Policy Machine reports using A.ITAM form data. These custom Policy Machine codes will not appear live in the form builder, only on the live form.

### Email

This field is a great choice when the user wants to collect an email address from the user's respondent. The field does provide some simple syntactic validation.

Expanding the field properties will present these options:
Field Label: Field Label is one or two words placed directly above the field.
Field Type: Field Type determines what kind of data can be collected by the user's field. After the user save the form, the field type cannot be changed.
Field Size: Small, Medium and Large field sizes are displayed.
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters.
Admin Only: By setting this value, the field will be pre-populated with the text the user enters.
Limit By Words or Characters: the user can limit the number of characters typed to be between certain characters or words, or between certain values in the case of number field. Leave the value blank or 0 if the user does not want to set any limit.
Default Value: By setting this value, the field will be pre-populated with the text the user enters.
Guidelines for User: This is an advanced option. the user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Custom CSS Class: This is an advanced option. the user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. the user can add a custom Policy Machine variable to the parent element of the field. This is useful if the user would like to generate Policy Machine reports using A.ITAM form data. These custom Policy Machine codes will not appear live in the form builder, only on the live form.

### Time

This field allows a user to collect time-based information from the user's respondent.

Expanding the field properties will present these options:
Field Label: Field Label is one or two words placed directly above the field.
Field Type: Field Type determines what kind of data can be collected by the user's field. After the user save the form, the field type cannot be changed.
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters.
Admin Only: By setting this value, the field will be pre-populated with the text the user enters.
Time Options:
   Displaying Hours (HH)
   Displaying Minutes (MM)
   Displaying Seconds (SS)
   Displaying a 24-hour format
Guidelines for User: This is an advanced option. The user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. The user can add a custom Policy Machine variable to the parent element of the field. This is useful if the user would like to generate Policy Machine reports using A.ITAM form data. These custom Policy Machine codes will not appear live in the form builder, only on the live form.

### Date

This field allows a user to include the acquisition of a date from the user's respondent.

Expanding the field properties will present these options:
Field Label: Field Label is one or two words placed directly above the field.
Field Type: Field Type determines what kind of data can be collected by the user's field. After the user save the form, the field type cannot be changed.
Date Format: the user can choose between American and European Date Formats
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters.
Admin Only: By setting this value, the field will be pre-populated with the text the user enters.
Date Options:
   Enable Minimum and/or Maximum Dates
   Enable Date Selection Limit
   Disable
   Disable Weekend Dates
   Disable Specific Dates
Default Date: By setting this value, the field will be pre-populated with the text the user enters.
   Formatting examples are:
      ##/##/####
      today
      tomorrow
      last Friday
      +1 week
      last day of next month
      3 days ago
      Monday next week
      next year
Guidelines for User: This is an advanced option. The user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. The user can add a custom Policy Machine variable to the parent element of the field. This is useful if the user would like to generate Policy Machine reports using A.ITAM form data. These custom Policy Machine codes will not appear live in the form builder, only on the live form.

### Number

This field allows for the collection or display of numbers to the user's form respondent. The user can limit the number of characters typed to be between certain characters or words, or between certain values in the case of number field. Leave the value blank or 0 if the user does not want to set any limits.

Expanding the field properties will present these options:
Field Label: Field Label is one or two words placed directly above the field.
Field Type: Field Type determines what kind of data can be collected by the user's field. After the user save the form, the field type cannot be changed.
Field Size: the user can choose between small, medium and large display formats.
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters.
Admin Only: By setting this value, the field will be pre-populated with the text the user enters.
Range: the user can limit the number of characters typed to be between certain characters or words, or between certain values in the case of number field. Leave the value blank or 0 if the user does not want to set any limit.
Advanced Options: Enable this option if the user's form has payment enabled and need to use quantity field to calculate the total price. Select the target field for the calculation from the dropdown list. Target field type must be one of the following: Multiple Choice, Drop Down, Checkboxes, and Price.
Default Value: By setting this value, the field will be pre-populated with the text the user enters.
Guidelines for User: This is an advanced option. The user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. The user can add a custom Policy Machine variable to the parent element of the field. This is useful if the user would like to generate Policy Machine reports using A.ITAM form data. These custom Policy Machine codes will not appear live in the form builder, only on the live form.

### Price

This field allows for the inclusion of currency fields.

Expanding the field properties will present these options:
Field Label: Field Label is one or two words placed directly above the field.
Field Type: Field Type determines what kind of data can be collected by the user's field. After the user save the form, the field type cannot be changed.
Currency Format: the user can choose from any currency.
Required: Checking this rule will make sure that a user fills out a particular field. A message will be displayed to the user if they have not filled out the field.
No Duplicates: By setting this value, the field will be pre-populated with the text the user enters.
Everyone: By setting this value, the field will be pre-populated with the text the user enters.
Admin Only: By setting this value, the field will be pre-populated with the text the user enters.
Range: the user can limit the number of characters typed to be between certain characters or words, or between certain values in the case of number field. Leave the value blank or 0 if the user does not want to set any limit.
Advanced Options: Enable this option if the user's form has payment enabled and need to use quantity field to calculate the total price. Select the target field for the calculation from the dropdown list. Target field type must be one of the following: Multiple Choice, Drop Down, Checkboxes, and Price.
Default Value: By setting this value, the field will be pre-populated with the text the user enters.
Guidelines for User: This is an advanced option. The user can add custom CSS class names to the parent element of the field. This is useful if the user would like to customize the styling for each of the user's field using the user's own CSS code. These custom class names will not appear live in the form builder, only on the live form.
Enable Field Notes: This option enables field notes which is a great collaboration tool enabling team messages with an active visual indication for all users to utilize.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced Policy Machine option. The user can add a custom Policy Machine variable to the parent element of the field. This is useful if the user would like to generate Policy Machine reports using A.ITAM form data. These custom Policy Machine codes will not appear live in the form builder, only on the live form.

### Web Site

This field allows a user to prepopulate a URL or allow the respondent the opportunity to input a URL. The field does some simple syntactic validation.

There are several customization options which are:
Field Label: Field Label is one or two words placed directly above the field.
Field Type: Field Type determines what kind of data can be collected by the user's field. After the user save the form, the field type cannot be changed.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Default Value: By setting this value, the field will be pre-populated with the text the user enters.
Guidelines for User: This text will be displayed to the user's users while they are filling out a particular field.
Enable Field Notes: This option enables field notes which is a great collaboration tool enabling team messages with an active visual indication for all users to utilize.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced option. If the user wants the respondent's form entry in this field to transfer into a document generated by the A.ITAM system, enter a unique contiguous policy machine code here.

### Syndication

This field allows the user to display formatted messages such as RSS feed information within the user's form displayed to the respondent. For example, advertisements or other important information may be displayed as many times as possible within a form that the user requires.

There are several customization options which are:
Field Label: Field Label is one or two words placed directly above the field.
Field URL: Field URL is used to enter in the URL of an RSS (Rich Site Summary; originally RDF Site Summary; often called Really Simple Syndication) that uses a family of standard web feed formats to publish frequently updated information: blog entries, news headlines, audio, video. An RSS document (called “feed”, “web feed”, or “channel”) includes full or summarized text, and metadata, like publishing date and author's name.
Feed Box Theme: Feed Box Theme allows the user to select a pre-built ITAM theme allowing the user to match the user's sites aesthetic needs.
Width: Width allows the user to choose the field's width when it is rendered to the respondent of the form. It is measured in pixels.
Height: Height allows the user to choose the field's height when it is rendered to the respondent of the form. It is measured in pixels.
Scroll Bar: Scroll Bar will display a side scroll capability in a live form that the respondent can use to manually scroll through the syndication content.
Auto Scroll: Auto Scroll simply automates the scrolling through of syndication content.
Scroll Speed: Scroll Speed allows the user to determine how fast the user want to auto scroll the user's syndication content in seconds.
Scroll Direction: Scroll Direction allows the user to display syndication content that scrolls in either a horizontal or vertical direction.
Message Count: Message Count allows the user to determine how many syndication messages are displayed in the active syndication field when a user sees it.
Datetime: Datetime allows the user to display to the user's viewers the date and time of the syndication content provided by the RSS URL.

### Multiple Choice

This field allows for the presentation of a variety of choices in a question format where only one of the responses may be selected. Question fields allow the user to create as simple or as complex a questionnaire field as needed. Use the plus and minus buttons to add and delete choices. Click on the choice to make it the default selection. Please enter a numeric value in the field adjacent to the response that may be used for risk weighting or other analytical calculations of the user's choice.

There are several customization options which are:
Field Label: Field Label is one or two words placed directly above the field.
Field Type: Field Type determines what kind of data can be collected by the user's field. After the user save the form, the field type cannot be changed.
Choices and Scores: Use the plus and minus buttons to add and delete choices. Click on the choice to make it the default selection. Please enter a numeric value in the field adjacent to the response that may be used for risk weighting or other analytical calculations of the user's choice. The score range is between 0-999 with up to two decimal points allowed.
Allow Clients to Add Other Choice: Enable this option if the user would like to allow the user's client to write his own answer if none of the other choices are applicable. A text field will be added to the last choice. Enter the label below this checkbox.
Randomize Choices: Enable this option if the user would like the choices to be shuffled around each time the form being displayed.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Guidelines for User: This text will be displayed to the user's users while they are filling out a particular field.
Enable Field Notes: This option enables field notes which is a great collaboration tool enabling team messages with an active visual indication for all users to utilize.
Enable Status Indicator: This is a great visual indicator of progress that helps to inform everyone what the status is in real time of the multitude of form fields, inputs and controls.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced option. If the user wants the respondent's form entry in this field to transfer into a document generated by the A.ITAM system, enter a unique contiguous policy machine code here.

### Checkboxes

This field allows for the presentation of a variety of choices in a question format where any or all of the responses may be selected. Question fields allow the user to create as simple or as complex a questionnaire field as needed. Use the plus and minus buttons to add and delete choices. Click on the choice to make it the default selection. Please enter a numeric value in the field adjacent to the response that may be used for risk weighting or other analytical calculations of the user's choice.

There are several customization options which are:
Field Label: Field Label is one or two words placed directly above the field.
Field Type: Field Type determines what kind of data can be collected by the user's field. After the user save the form, the field type cannot be changed.
Choices and Scores: Use the plus and minus buttons to add and delete choices. Click on the choice to make it the default selection. Please enter a numeric value in the field adjacent to the response that may be used for risk weighting or other analytical calculations of the user's choice. The score range is between 0-999 with up to two decimal points allowed.
Allow Clients to Add Other Choice: Enable this option if the user would like to allow the user's client to write his own answer if none of the other choices are applicable. A text field will be added to the last choice. Enter the label below this checkbox.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Guidelines for User: This text will be displayed to the user's users while they are filling out a particular field.
Enable Field Notes: This option enables field notes which is a great collaboration tool enabling team messages with an active visual indication for all users to utilize.
Enable Status Indicator: This is a great visual indicator of progress that helps to inform everyone what the status is in real time of the multitude of form fields, inputs and controls.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced option. If the user wants the respondent's form entry in this field to transfer into a document generated by the A.ITAM system, enter a unique contiguous policy machine code here.

### Matrix Choice

This field allows for the presentation of a variety of choices in a question matrix format where only one of the responses may be selected. Question fields allow the user to create as simple or as complex a questionnaire field as needed. Use the plus and minus buttons to add and delete choices. Click on the choice to make it the default selection. Please enter a numeric value in the field adjacent to the response that may be used for risk weighting or other analytical calculations of the user's choice.

There are several customization options which are:
Field Label: Field Label is one or two words placed directly above the field.
Field Type: Field Type determines what kind of data can be collected by the user's field. After the user save the form, the field type cannot be changed.
Columns and Scores: Use the plus and minus buttons to add and delete choices. Click on the choice to make it the default selection. Please enter a numeric value in the field adjacent to the response that may be used for risk weighting or other analytical calculations of the user's choice. The score range is between 0-999 with up to two decimal points allowed.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Allow Multiple Answers Per Row: Checking this option will allow the user's client to select multiple answers for each row. This option can only be set once when the user initially added the matrix field. Once the user has saved the form, this option cannot be changed.
Enable Field Notes: This option enables field notes which is a great collaboration tool enabling team messages with an active visual indication for all users to utilize.
Enable Status Indicator: This is a great visual indicator of progress that helps to inform everyone what the status is in real time of the multitude of form fields, inputs and controls.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced option. If the user wants the respondent's form entry in this field to transfer into a document generated by the A.ITAM system, enter a unique contiguous policy machine code here.

### Drop Down

This field allows for the presentation of a variety of choices in a question with a drop-down style format where only one of the responses may be selected. Question fields allow the user to create as simple or as complex a questionnaire field as needed. Use the plus and minus buttons to add and delete choices. Click on the choice to make it the default selection. Please enter a numeric value in the field adjacent to the response that may be used for risk weighting or other analytical calculations of the user's choice.

There are several customization options which are:
Field Label: Field Label is one or two words placed directly above the field.
Field Type: Field Type determines what kind of data can be collected by the user's field. After the user save the form, the field type cannot be changed.
Field Size: Field Size allows the user to scale the signature field larger or smaller depending on the user's needs.
Choices and Scores: Use the plus and minus buttons to add and delete choices. Click on the choice to make it the default selection. Please enter a numeric value in the field adjacent to the response that may be used for risk weighting or other analytical calculations of the user's choice. The score range is between 0-999 with up to two decimal points allowed.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Guidelines for User: This text will be displayed to the user's users while they are filling out a particular field.
Enable Field Notes: This option enables field notes which is a great collaboration tool enabling team messages with an active visual indication for all users to utilize.
Enable Status Indicator: This is a great visual indicator of progress that helps to inform everyone what the status is in real time of the multitude of form fields, inputs and controls.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced option. If the user wants the respondent's form entry in this field to transfer into a document generated by the A.ITAM system, enter a unique contiguous policy machine code here.

### File Upload

This field allows the form respondent the ability to upload files into the A.ITAM system.

Every file that is uploaded into the A.ITAM system is registered into the systems blockchain directory contract registry. This feature provides immutability of evidence.

There are several customization options which are:
Field Label: Field Label is one or two words placed directly above the field.
Field Type: Field Type determines what kind of data can be collected by the user's field. After the user save the form, the field type cannot be changed.
Field Size: Field Size allows the user to scale the signature field larger or smaller depending on the user's needs.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Upload Options:
   Limiting the uploadable file types to block a certain file type.
   Limiting the uploadable file types to only allow a certain file type.
   Limiting the uploadable file quantity to a predefined number of files.
   Limiting the uploadable file size to a predefined maximum file size limitations.
Guidelines for User: This text will be displayed to the user's users while they are filling out a particular field.
Enable Field Notes: This option enables field notes which is a great collaboration tool enabling team messages with an active visual indication for all users to utilize.
Enable Status Indicator: This is a great visual indicator of progress that helps to inform everyone what the status is in real time of the multitude of form fields, inputs and controls.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced option. If the user wants the respondent's form entry in this field to transfer into a document generated by the A.ITAM system, enter a unique contiguous policy machine code here.

### Signature

This field allows the respondent to be able to add a signature to the form results.

There are several customization options which are:
Field Label: Field Label is one or two words placed directly above the field.
Field Type: Field Type determines what kind of data can be collected by the user's field. After the user save the form, the field type cannot be changed.
Field Size: Field Size allows the user to scale the signature field larger or smaller depending on the user's needs.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Guidelines for User: This text will be displayed to the user's users while they are filling out a particular field.
Enable Status Indicator: This is a great visual indicator of progress that helps to inform everyone what the status is in real time of the multitude of form fields, inputs and controls.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.
Policy Machine Code: This is an advanced option. If the user wants the respondent's form entry in this field to transfer into a document generated by the A.ITAM system, enter a unique contiguous policy machine code here.

### Section Break

This field allows the user to divide a form into individual sections that appear all on the same page. Options to include preformatted text is present. A popular use of this field is for narratives and informational sections in a form making it more descriptive and meaningful to the user's respondents.

There are several customization options which are:
Field Label: Field Label is one or two words placed directly above the field.
Field Type: Field Type determines what kind of data can be collected by the user's field. After the user save the form, the field type cannot be changed.
Field Visible to:
   Everyone: This is the default option. The field will be accessible by anyone when the form is made public.
   Admin Only: Fields that are set to “Admin Only” will not be shown to users when the form is made public.
Section Break Options:
Display Section Break in Email: Enable this option if the user needs to display the content of the section break within the notification email, review page and entries page.
Enable Scrollbar: The section break will be set to a fixed height and a vertical scrollbar will be displayed as needed. This is useful to display a large amount of text, such as terms and conditions, or contract agreements. Choose from Small, Medium, and Large.
Guidelines for User: This text will be displayed to the user's users while they are filling out a particular field.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.

### Page Break

This field allows the user's form to have multiple pages. There is really no limitation to how many pages the user may have in a form as long as they are not blank pages.

There are two options which are:
Use Text Button: This is the default and recommended option. All buttons will use simple text. The user can change the text being used on each page submit/back button. The user may modify the default values easily.
Use Image Button: Select this option if the user prefers to use the user's own submit/back image buttons. Make sure to enter the full URL address to the user's images. The user may modify the default values easily.

### Cascade Form

This field allows the user to connect multiple forms together creating a contiguous experience for the user's respondents. If the user want to simplify really complex forms with common templates that the user “stitch” or link together. When the user place this field into position anywhere in the user's main form the user are presented with a multiple choice drop down selector containing all the active forms in the user's current inventory. The user is able to cascade multiple separate forms together. The user is also able to cascade within a cascaded form creating complex form nesting scenarios. The form fields will assume the name of the cascaded form name present in the drop-down form selector. The results of the respondent entries will stay with the specific forms cascaded together quite elegantly. Any form that is connected by a cascade field will independently update data when a user enters information and in addition to the separate form data set, the updates flow upwards to the top-level cascade form data set. Bi-directional data management is possible with the top-level collation of all separate form data into one unified experience and report output. Expanding the field properties will present these options: Choosing Form to Cascade: This is an advanced option. The user chooses any active

form from the list and automatically link it into position; and Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.

### Chat

This field allow for the addition of chat functionality to the user's forms. With the Chat feature it would connect the user's clients to the user's support team in real-time, enhancing the user's customer support and improving the user's businesses support reputation.

There are several customization options which are:
Field Label: Field Label is one or two words placed directly above the field.
Field Type: Field Type determines what kind of data can be collected by the user's field. After the user save the form, the field type cannot be changed.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Chat Connector: This section contains the chat server link parameters.
Guidelines for User: This text will be displayed to the user's users while they are filling out a particular field.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.

### Media Player

This field presents a variety of media selections such as MP4 videos, external URL-based links to video content, MP3 audio content and image files such as PNG, JPG and GIF files. Display attributes are automatically scaled to the form's width, but a pop-up window feature allows for full screen viewing too. Display training content, advertisements, instructional and informational content or anything relevant to the user's current modules form content for a rich multimedia experience.

There are several customization options which are:
Field Label: Field Label is one or two words placed directly above the field.
Field Type: Field Type determines what kind of data can be collected by the user's field. After the user save the form, the field type cannot be changed.
Rules: If the user wants to require the respondent to submit a response in this field, check this option and the user's user cannot advance to another page or submit a form without completing this field.
Field Visible to:
   Everyone: This is the default option. The field will be accessible by anyone when the form is made public.
   Admin Only: Fields that are set to “Admin Only” will not be shown to users when the form is made public.
Media Player Configuration: Parameters to control the presentation and placement of video and graphic files include settings for:
   Size
   Position
   Auto Play
   Repeat
   Media Location
   Upload File
Guidelines for User: This text will be displayed to the user's users while they are filling out a particular field.
Enable Field Notes: This option enables field notes which is a great collaboration tool enabling team messages with an active visual indication for all users to utilize.
Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.

### A.ITAM User Menus

Manage Forms: Forms Manager features several tools to facilitate more effective and efficient forms management. These become especially useful as organizations develop an extensive number of custom forms.
Manage Reports: Create, edit and manage the user's reports using the Create New Report tool. Analysis and comparison of existing form data may be computed and assigned to a user. Administrators create reports that will be dynamically updated by updates.
Edit Themes: The Theme Editor allows users that are granted the Create New Theme privilege the ability to customize nearly every aspect of a form's visual appearance. The value of this comes in creating forms that visually communicate a corporate, product, project, or other relevant theme so as to reinforce the organizations branding or to delineate certain groups of forms from others within the same organization.
My Users: The Users Manager interface consists of a main table that displays all users with access to the user's instance of the system.
My Account: Users will manage basic account and login information from the My Account screen accessible via the My Account button on the main menu.
Settings: The System Settings interface allows the administrator to define a variety of system wide settings.
Catalog: The Catalog menu option is how users find forms that are available to them and may be subscribed to activate them for usage.
My Forms: The My Forms menu option is where users go to use forms they already have subscribed to and are actively using.
My Documents: The My Documents menu option is where users will go to download the reports, documents, policies, and all other output documents produced automatically by the system.
My Reports: The My Reports menu option is where users go to view their analytic and report graphic charts that are updated in real-time as their data is updated.
Entity Information: The Entity Information menu option is where users manage other participants in the system. A user may invite other users to join their collaboration group and participate in assessments, questionnaires, surveys and all manner of forms made available to users.
My Account: The My Account menu option is where a user may manage their own account parameters such as passwords and email addresses.

### Form Field Properties

The Form Builder allows the user to select and place form design elements from a variety of predefined field type elements, define field specific properties, and also to define form specific properties. Upon saving the design of the new form, the user will be redirected back to the Form Manager page and the new form will be displayed in the list of available forms.

The Form Builder is graphically and functionally divided into two main columns. The left column is the workspace area and also serves as a preview of the form design. The right column serves as the forms toolbox interface from which users can select to add fields, change field properties, and change the properties of the form. Note that while the preview section displays a general layout preview of the form any associated theme is not displayed within the preview. Custom themes are only displayed when viewing the live form.

### Form Properties

The global properties of each form are controlled by a set of configuration parameters that are unique to each form.

There are several customization options which are:
Form Title: The title of the user's form displayed to the user when they see the user's form.
Description: This will appear directly below the form name. Useful for displaying a short description or any instructions, notes, guidelines.
Submission Confirmation:
   Show Text: This message will be displayed after the user's users have successfully submitted an entry. The user can enter any HTML codes, JavaScript codes or Template Variables as well.
   Redirect to Web Site: After the user's users have successfully submitted an entry, the user can redirect them to another website/URL of the user's choice. The user can insert Template Variables into the URL to pass form data.
Language: This option allows the user to choose the language being used to display the user's form messages. Keep in mind that the language function is only to display the preformatted text in the selected language. The user must type in the user's optional text using the appropriate characters which are associated with the user's computer's local language settings. Any language is provided as an option.
Label Alignment: This option allows the user to set the field label placement which currently is:
   Top Aligned
   Left Aligned
   Right Aligned
Allow Clients to Save and Resume Later: Checking this will display additional link at the bottom of the user's form which would allow the user's clients to save their progress and resume later. This option is only available if the user's form has at least two pages (has one or more Page Break field).
Show Review Page Before Submitting: If enabled, the user's clients will be prompted to a preview page that lets them double check their entries before submitting the form.
Turn On Password Protection: If enabled, all users accessing the public form will then be required to type in the password to access the form. The user's form is password protected.
Turn On Spam Protection (CAPTCHA): If enabled, an image with random words will be generated and users will be required to enter the correct words to be able to submit the user's form. This is useful to prevent abuse from bots or automated programs usually written to generate spam. the user can select the difficulty level of the spam protection which include:
   reCAPTCHA: Display an image with distorted words. An audio also included. This is the most secure but also the hardest to read. Some people might find this annoying.
   Simple Image: Display an image with clear and sharp words. Most people will find this easy to read.
   Simple Text: Display a text (not an image) which contain simple questions to solve.
Limit One Entry Per IP: Use this to prevent clients from filling out the user's form more than once. This is done by comparing client's IP Address.
Enable Form Availability: If the user would like to schedule the user's form to become active at certain period of time only, enable this option. The optional parameters are:
   Only Accept Submission From Date: This is the date and time the user want to open availability to users of the form.
   Until Date: This is the date and time the user wants to close availability to users of the form.
Upload Templates: Output documents and spreadsheets generated by the A.ITAM system start as templated versions. These documents may be highly customized to
Load Custom JavaScript File: the user can register the user's own custom JavaScript file to run in line with the form. The user's script will be loaded each time the form is displayed.
Private Form: Select this option to prevent subscribers from viewing and subscribing to administrative forms.
Primary Form Entity Owner: Set the primary owner of the form to a particular entity. All form data created will belong to this entity.
Secondary Entity Owner: Select All to make this form available to every user. Select one entity or control-click several to provision access to only those designated entities. Data ownership resides with the primary entity.

### Notification Settings

Each form created allows for form specific email notification/confirmation upon successful submission of a record entry using the specified form. Administrators/Form Designers have the ability to customize several email notification parameters. Access to a forms email notification settings are provided via the notification button/tab below the form entry in the Form Manager.

Regardless of the form the user are working with, the Notification options are the same and only applicable to that specific form which gives the user a powerful feature to manage how information notification flows are controlled. Options include:
Send Notification Emails to My Inbox: Enable this option to send all successful form submission to the user's email address (all the data will still be accessible from the user's admin panel as well).
Send Confirmation Email to User: Enable this option to send confirmation email to the user after successful form submission. The user's form need to have an email field to use this option.
Send Form Data to Another Website: the user can enable this option to send form data to any other custom URL. Useful to integrate the user's form with many other web applications, such as Continuum GRC, MailChimp, Salesforce, Basecamp, etc.
Send Administrative Notices to User: Enable this option to send administrative notices to users based on a schedule.
Send Reminder Notices to User: Enable this option to send administrative follow up notices to users based on a schedule.

### Logic Builder

Among the features available in the A.ITAM system 400 are the built-in conditional logic functions for forms and pages. The “Logic Builder” is the control window where form designers are able to define specific business rules for certain types of form/page behavior. The Logic Builder is accessed from the advanced features tab of the drop-down menu when selecting the form.

Using this feature, form designers are able to dynamically show/hide fields based on selections being made by the user and/or to skip to a certain page. This is very useful if it is necessary to display different form content to various users without creating numerous forms with many redundant fields or having a single form with too many fields. Other options include:
Enable Rules to Show/Hide Fields: Enable this option to show or hide fields on the form based on the value of another fields. Useful for displaying different set of fields based on user choices.
Enable Rules to Skip Pages: Enable this option to allow users to jump into the success page or go to any specific page based on their choices. Useful when the user have multipage form and need to display different set of pages based on user choices.
Enable Rules to Send Notification Emails: Enable this option to send additional notification emails to any email address based on user choices. The user can customize the email content, subject, and address based on user choices.
Enable Rules to Send Form Data to Another Website: This is an advanced option. Enable this option to send additional webhooks to any other URLs based on user choices.
Enable Rules to Add approvers for this form: This is an advanced option. Enable this option to Add approvers for this form based on user choices. Options include Single-Step Approval and Multi-Step Approvals for authorized administrators to manage the assessment submission workflow.
Approve/Deny Notification Logic: This is an advanced option. Enable this option to add approver event triggers that move the notification workflows, approver milestone events and delegations through the workflow process.

The A.ITAM system 400 provides an analytics dashboard output, where all data sets available within the system may be analyzed and displayed in dashboard-style graphic renderings that are updated in real-time as additional data inputs are put into the system. These documents are produced from pre-formatted templates that are automatically generated to report user-based and A.ITAM inputs. Typically, all the system data sets are displayed to users through application interfaces. The resident data may be updated and managed according to the user's requirements. This smart digital hub allows multiple users to collaborate or work independently depending on their requirements. The aforementioned logic builder application interface allows the definition of conditions and actions for form fields, pages, or notification emails. Rules may be enabled to automatically show or hide fields. Rules may be enabled to skip pages, where a destination page may be selected, and where conditions for skipping pages may be entered. A plurality of rules may also be entered.

Website integration user interfaces allow for rules to be enabled to automatically send form data to other websites, based on conditions. Thus, a destination URL may be entered, and HTTP methods may be selected (e.g., HTTP POST). The use of HTTP authentication and custom HTTP headers may be toggled. A data format may be selectable, such as sending key-value pairs, or sending raw data. Parameters may be entered for key-value pairs, such as FormID, Entry Number, entry_no, DateCreated, and/or IP Address. Further, rules may be enabled or disabled to add approvers of a particular form (e.g., single-step approval or multi-step approval). Rules may be enabled to allow approval or denial from any user or only selected users. An option may be included to require unanimous approval. For example, email addresses of users may be entered to qualify them for any of these roles. Notification logic may be implemented for approval and denial of forms. For example, if certain conditions are present, approval or denial may be notified. A form code may also be defined that allows users to generate forms via the form code. A form code (i.e., programming code) may be entered to automatically integrate a form into a website or a form code may be copied and pasted into a website page. The code will insert a form into an existing web page seamlessly, and form background, border, or header logos may not be displayed.

Significantly, the A.ITAM system 400 employs a parallel analysis and processing employing supervisory machine learning models and unsupervised machine learning models. ML algorithms iteratively learn from data, thus allowing the A.ITAM system 400 to identify

hidden insights without being explicitly programmed where to look. As will be appreciated, machine learning is essentially teaching a computer to solve problems by creating algorithms and models that learn by looking at hundreds or thousands of examples, and then using that experience to solve the same problem in new situations. Machine Learning tasks are typically classified into the following three broad categories, depending on the nature of the learning signal or feedback available to a learning system: supervised learning, unsupervised learning, and reinforcement learning. In supervised learning, the algorithm trains on labeled historic data and learns general rules that map input to output/target. In particular, the discovery of relationships between the input variables and the label/target variable in supervised learning is done with a training set. The computer/machine learns from the training data. In this approach, a test set is used to evaluate whether the discovered relationships hold, and the strength and utility of the predictive relationship is assessed by feeding the model with the input variables of the test data and comparing the label predicted by the model with the actual label of the data. Known supervised learning algorithms include, but are not limited to, support vector machines, linear regression, logistic regression, naive bayes, and neural networks. In unsupervised machine learning, the algorithm trains on unlabeled data. The goal of these algorithms is to explore the data and find some structure within. Known unsupervised learning algorithms include, but are not limited to, cluster analysis and market basket analysis. In reinforcement learning, the algorithm learns through a feedback system. The algorithm takes actions and receives feedback about the appropriateness of its actions and based on the feedback modifies the strategy and takes further actions that would maximize the expected reward over a given amount of time.

As noted above, supervised learning is the machine learning task of inferring a function from labeled training data. The training data consist of a set of training examples. In supervised learning, typically each example is a pair consisting of an input object (typically a vector), and a desired output value (also called the supervisory signal). A supervised learning algorithm analyzes the training data and produces an inferred function, which can be used for map-ping new examples. An optimal scenario allows for the algorithm to correctly determine the class labels for unseen instances. This requires the learning algorithm to generalize reasonably from the training data to unseen situations.

To solve or analyze a problem or scenario using supervised learning, a variety of steps is typically performed. An initial task is for the user to decide what kind of data is to be used as a training set. This provides for gathering a training set that is representative of the real-world use of the function. Thus, a set of input objects is gathered, and corresponding outputs are also gathered, either from human experts or from measurements. Then determine the input feature representation of the learned function. The accuracy of the learned function depends strongly on how the input object is represented. Typically, the input object is transformed into a feature vector, which contains a number of features that are descriptive of the object. The structure of the learned function and corresponding learning algorithm are then determined. For example, the user may choose to use support vector machines or decision trees. The learning algorithm is then run on the gathered training set. Some supervised learning algorithms require the user to determine certain control parameters. These parameters may be adjusted by optimizing performance on a subset (i.e., a validation set) of the training set, or via cross-validation. The accuracy of the learned function is then evaluated. After parameter adjustment and learning, the performance of the resulting function is measured on a test set that is separate from the training set.

In this way, the above-detailed supervisory training model is employed for recursive processing and learning with respect to the supervised A.ITAM training data 200 and the sanitized supervised A.ITAM ML training data 206. The sanitized supervised A.ITAM ML training data 206 received at step 110 is provided as one input, at step 112 to an A.ITAM machine learning model that builds upon user input/new data for learning and improving overall form development and compliance. The unsupervised machine learning undertaken by the A.ITAM system 400 is directed to looking for patterns and/or trends in unlabeled data for suggesting potential user responses for a form's field types and data entry. These patterns and trends are not ones that a user may necessarily be looking for or familiar with. The unsupervised A.ITAM data set is stored in an unsupervised A.ITAM data database 208. Thus, at step 112, there is the applying of a machine learning compliance and risk model for iteratively learning (i) using a plurality of real-time user input data 202 and outputting a cohort data set and (ii) using a plurality of unlabeled data for identifying one or more patterns or trends and outputting an unsupervised A.ITAM data set. At step 114, storing the cohort A.ITAM data in cohort data

database 210. Cohort A.ITAM data is a compilation of external data sets that are similar to the user's data (i.e., the user input data 202) and that has been processed by the machine learning A.ITAM application code. The end user is presented with a recommended response they may choose to accept. This automation improves the quality of the user's input responses while speeding up the completion of these types of tasks. In addition to processing the user input data 202, historical user data is received from a historical user data database 204. The historical user data is a repository of user input data collected over time and allows for additional machine learning. Illustratively, the user creates and inputs text-based data responses, file uploads, and selection-based responses into the user interface that includes of a variety of purpose created forms. These forms are a compilation of text fields, response selections, uploads, and automated inputs from external data sources. The user input is transferred into a backend by the A.ITAM system 400.

Furthermore, the illustration of FIG. 3 also shows a schematic system position of historical data inputs, where the backend database and application code helps store, manage, present, and interact with users. The information includes historical data inputs made previously by users that is ingested by the automated AI cognitive machine learning software where it is made available to users as needed. At step 134, a determination is made whether data operations are to continue. If so, the processing moves to a user-centric review of the user historical data, the unsupervised A.ITAM data, and/or the cohort A.ITM data. The user is respectively queried at steps 116, 120, and 124 about their desire for such data review and based on their input the user historical data, the unsupervised A.ITAM data, and/or the cohort A.ITM data is retrieved (at steps 118, 122, and/or 126, as the case may be) and displayed at step 128. At step 130, the user is queried whether the displayed data is acceptable and if so, the operations return to step 108. If not, corrections are made at step 132 and the operations continue at step 128.

The processing of the user historical data, the unsupervised A.ITAM data, and/or the cohort A.ITM data and application of the machine learning models therewith provides for deriving one or more recommended inputs for at least one labeled data set associated with particular one form using the historical user data, the supervised training data set, the cohort data set, and the unsupervised A.ITAM data set. This facilitates presenting, through a graphical user

interface (e.g., the user interface 314), the one or more recommended inputs derived for selection and use in completing the particular one form.

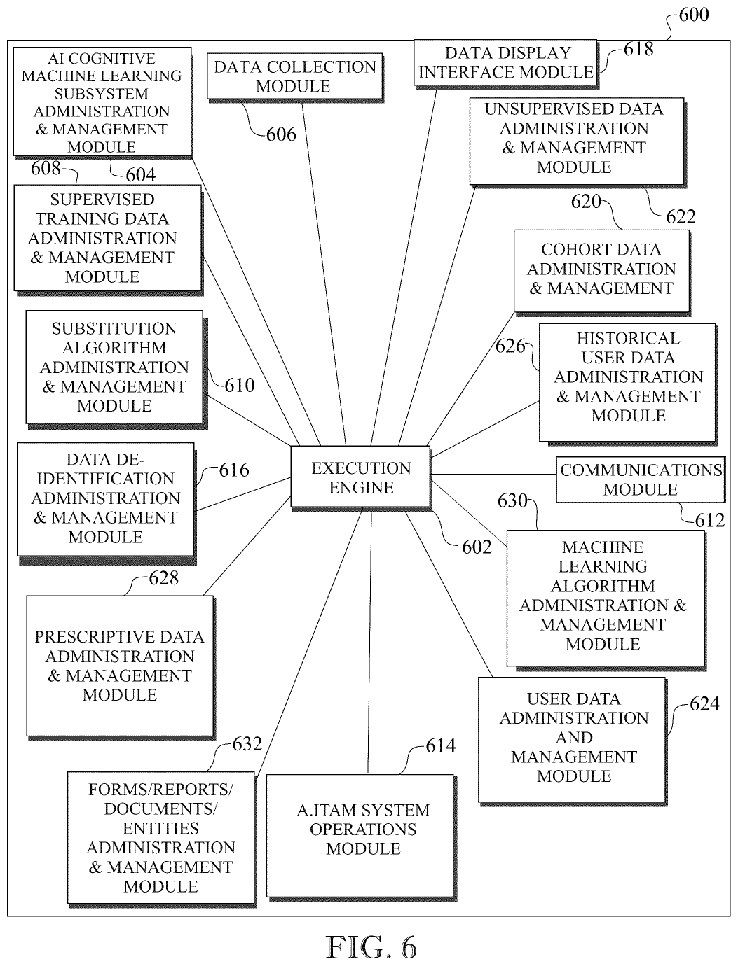

As shown in the cloud network services architecture 300, the A.ITAM system 400 interacts with and employs the user input data database 202, the user historical data database 204, the supervised A.ITAM ML training data database 200, sanitized A.ITAM supervised ML training data database 206, unsupervised A.ITAM ML data database 208, cohort A.ITAM data database 210 and A.ITAM system data database 212. Further, the A.ITAM system 400 comprises AI cognitive machine learning algorithm subsystem 304 which facilitates at least the aforementioned ML operations and various data processing. The AI cognitive machine learning algorithm subsystem 304 further comprises a plurality of modules for undertaking such operational execution in conjunction with the A.ITAM system 400 and the A.ITAM app 600 (see, e.g., FIG. 6): A.TAM supervised training data module 304-1, A.ITAM substitution algorithm model 304-2, supervised data de-identification module 304-3, A.ITAM cohort data module 304-4, unsupervised A.ITAM ML data module 304-5, user data module 304-6, historical user data module 304-7, A.ITAM ML prescriptive data module 304-8, and A.ITAM machine learning algorithm module 304-9. In this way, the A.ITAM system 400 manages, stores, updates and curates pertinent regulatory codes, requirements, laws and incidental documentaries and advises on their use and impacts of failing to comply. The aforementioned modules utilize, process, learn and manipulate a variety of A.ITAM information 306 comprising auto-generated pre-formatted templates, real-time data sets, and other pertinent GRC information. In this way, the A.ITAM AI cognitive machine learning algorithm subsystem 304 and the A.ITAM system

400 are capable of producing GRC outputs 308 comprising an analytics dashboard 308-1, documentation 308-2, data management 308-3, forms 308-4, reports 308-5 and other pertinent
GRC output 308-6.

Turning our attention to FIG. 4, an illustrative block diagram of the A.ITAM system 400 is shown in accordance with an embodiment. More particularly, the A.ITAM system 400 comprises processor 402 for executing program code (e.g., the A.ITAM app 600 configured in accordance with FIG. 6) and communications interface 414 for managing communications to and from the A.ITAM system 400, memory 406 and read-only memory (ROM) 408 for storing

program code and data, and power source 418 for powering the A.ITAM system 400. The memory 406 is coupled to the bus 404 for storing computer-readable instructions (e.g., non-transitory computer readable medium) to be executed by the processor 402 including, but not limited to, the A.ITAM app 600. Database manager 412 is used to manage the delivery and storage of content, data, and other information in various database(s) types (including but not limited to, the user input data database 202, the user historical data database 204, the supervised A.ITAM ML training data database 200, sanitized A.ITAM supervised ML training data database 206, unsupervised A.ITAM ML data database 208, cohort A.ITAM data database 210 and A.ITAM system data databased 212) necessary and/or useful in delivering the GRC operations and services hereunder.

Web and mobile API manager 420 is used to deliver and manage content, data, and other information across one or more web-based applications and mobile-based applications, as the case may, that may be utilized to access and use the A.ITAM system 400, for example. Further, the operations provided by and through the A.ITAM app 600 may be offered, in whole or in part, through a web-based application in addition to the mobile-based application. For example, web Integration functionalities may include JavaScript Code, Iframe Code, PHP Embedded Code, PHP Form File Code, Simple Link Code, and Popup Link Code. As will be discussed in greater detail herein below, the A.ITAM app 600, as stored in data storage 410, when executed by the processor 402 will enable access by a plurality of users to the GRC operations and services in accordance with the disclosed embodiments. Such processing is further enabled by AI cognitive machine learning subsystem manager 422, A.ITAM system data manager 424, supervised data and algorithm manager 426, unsupervised data and algorithm manager 428, cohort data and algorithm manager 430, forms manager 432, reports manager 434, themes manager 436, entity manager 438, and blockchain manager 440.

In an embodiment, the operations provided through the execution of the A.ITAM app 600 may also include a web-based delivery platform and/or accessing and interfacing any number of websites using the web and mobile API manager 420 for procuring information and data that can be used in the A.ITAM system 400. The term “website” in the context herein is used in a conventional and broadest sense and is located on at least one server containing web

pages stored thereon and is operational in a 24-hour/7-day typical fashion. The A.ITAM system 400 may also include one or more input/output devices 416 that enable user interaction with the various user devices (e.g., camera, display, keyboard, mouse, speakers, microphone, buttons, etc.). The input/output devices may include peripherals, such as an NFC device (e.g., NFC tag reader), camera, printer, scanner (e.g., QR-code scanner), touchscreen display, etc. For example, the input/output devices 416 may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device or an associated display device, for example.

The communications interface 414 is used to facilitate communications across the communications links 302 (see, e.g., FIG. 3) within the cloud network services architecture 300. This may take the form, for example, of a wide area network connection that communicatively couples the A.ITAM system 400 with one or more access points which may include a cellular communications service. Similarly, communications managed by the communications interface 414 may take the form, for example, of a local Wi-Fi network interface or Ethernet interface the communicatively couples the A.ITAM system 400 with the well-known Internet, and ultimately to any user device 500. In the instant embodiment, the A.ITAM app 600 and/or the communications interface 414 may include a communications stack for facilitating communications over the respective communications link 302. Electronic communications by and through the A.ITAM system 400 between the various systems, networks, devices, users, entities, and/or individuals are facilitated by the communications links 302 in accordance with any number of well-known communications protocols and methods (e.g., wireless communications).

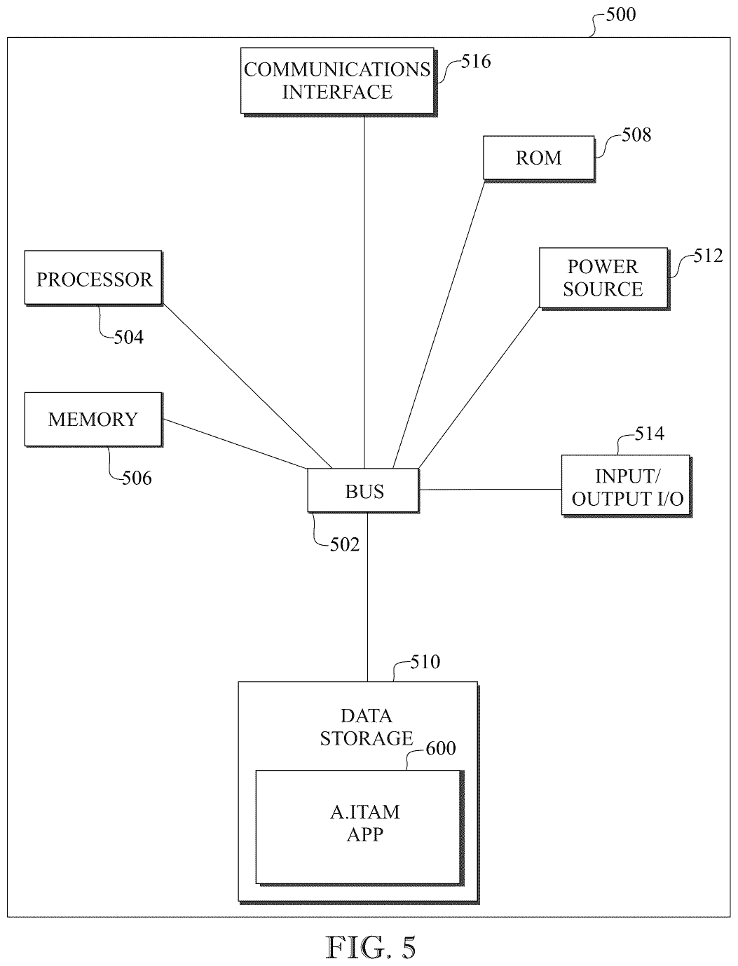

Turning our attention to FIG. 5, an illustrative user device 500 is shown for use with the A.ITAM system 400, for example, in accordance with an embodiment. The user device 500 typically includes bus 502 and processor 504 coupled to the bus 502 for executing operations and processing information. As will be appreciated, a “user device” in the context herein may comprise a wide variety of devices such as any type of hardware device, user devices,

smartphones, laptop computers, desktop computers, tablets, and wearable devices, to name just a few, that execute applications (e.g., a mobile application) in accordance with the principles of the disclosed embodiments herein. For example, the execution of the A.ITAM app 600 as detailed herein. The processor 504, as powered by power source 512, may include both general and special purpose microprocessors, and may be the sole processor or one of multiple processors of the device. This is equally applicable to the processor 402 of FIG. 4. Further, the processor 504 (or the processor 402) may comprise one or more central processing units (CPUs) and may include, be supplemented by, or incorporated in, one or more application-specific integrated circuits (ASICs) and/or one or more field programmable gate arrays (FPGAs).

The user device 500 may also include memory 506 coupled to the bus 502 for storing computer-readable instructions to be executed by the processor 504. The memory 506 may also be utilized for storing temporary variables or other intermediate information during the execution of the instructions by the processor 504. The user device 500 may also include ROM 508 or other static storage device coupled to the bus 502. Further, data storage device 510, such as a magnetic, optical, or solid-state device may be coupled to the bus 502 for storing information and instructions for the processor 504 including, but not limited to, the A.ITAM app 600. Data storage device 510 (or the data storage device 410) and the memory 506 (and the memory 406) may each comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The user device 500 may also include one or more communications interface 516 for communicating with other devices via a network (e.g., a wireless communications network) or

communications protocol (e.g., Bluetooth®). For example, such communication interfaces may be a receiver, transceiver, or modem for exchanging wired or wireless communications in any number of well-known fashions. For example, the communications interface 516 (or the communications interface 414) may be an integrated services digital network (ISDN) card or modem/router used to facilitate data communications of various well-known types and formats. Further, illustratively, the communications interface 516 (or the communications interface 414) may be a local area network (LAN) card used to provide data communication connectivity to a comparable LAN.

As will be appreciated, the functionality of the communication interface 516 (or the communications interface 414) is to send and receive a variety of signals (e.g., electrical, optical, or other signals) that transmit data streams representing various data types. The user device 500 may also include one or more input/output devices 514 that enable user interaction with the user device 500 such as a camera, display, keyboard, mouse, speakers, microphone, buttons, etc. The input/output devices 514 (or I/O devices 416) may include peripherals, such as an NFC device (e.g., NFC reader), camera, printer, scanner (e.g., QR-code scanner), touchscreen display, etc. For example, the input/output devices 514 (or the I/O devices 416) may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 500 or an associated display device, for example.

Turning our attention to FIG. 6, an illustrative architecture for a A.ITAM app 600 for delivering and executing the aforementioned GRC operations, system, platform and services in accordance with an embodiment. As will be appreciated, the architecture may be used, illustratively, in conjunction with the cloud network services architecture 300, the A.ITAM app 600, and/or the user device 500 for launching and executing the A.ITAM app 600. As shown, the architecture for the operations of the A.ITAM app 600 provides several interfaces and engines used to perform a variety of functions such as the collection, aggregation, manipulation, processing, analyzing, verification, authentication, and display of applicable real-time information and data that are useful to realize the delivery of GRC operations for storing,

accessing and managing electronic documents of various types in a secure fashion, as detailed herein. More particularly, data display interface module 618 and communications module 612 are used to facilitate the input/output and display of electronic data and other information to, illustratively, the users employing the user device 500 (e.g., a touch screen) for engaging with the A.ITAM app 600 and the execution thereof. The data collection module 606 facilitates data gathering from a plurality of users and other third parties.

Execution engine 602 may be employed to deliver the operations pursuant to the execution of the A.ITAM app 600. In such delivery, the execution engine 602 will operate and execute, as further detailed herein below, with at least the following program modules: AI cognitive machine learning subsystem administration and management module 604, data collection module 606, supervised training data administration and management module 608, substitution algorithm administration and management module 610, communications module 612, A.ITAM system operations module 614, data de-identification administration and management module 616, data display interface module 618, cohort data administration and management module 620, unsupervised data administration and management module 622, user data administration and management module 624, historical user data administration and administration module 626, prescriptive data administration and management module 628, machine learning algorithm administration and management 630, and forms, reports, documents, entities administration and management module 632. In an embodiment, the data display interface module 618, and the communications module 612 are used to facilitate the input/output and display of electronic data and other information (e.g., a graphical user interface) to, illustratively, the users employing the user device 500 (e.g., a touch screen of the user device 500) and executing the A.ITAM app 600 including, but not limited to, the operations executed by each and every of the foregoing modules are, for example, as discussed throughout this disclosure.

Those skilled in the art will appreciate that the present disclosure contemplates the use of systems configurations and/or computer instructions that may perform any or all of the operations detailed herein above. For example, the disclosure of computer instructions that include, for example, the A.ITAM system 400 and the A.ITAM app 600 is not meant to be

limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. Accordingly, the applications and programs, for example, may be written using any number of programming languages and/or executed on compatible platforms including, but not limited to, JavaScript, PHP (PHP: Hypertext Preprocessor), WordPress, Drupal, Laravel, React.js, Angular.js, and Vue.js. Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions (e.g., non-transitory computer readable mediums) may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (e.g., using an Internet Service Provider), or the connection may be made to external computers.

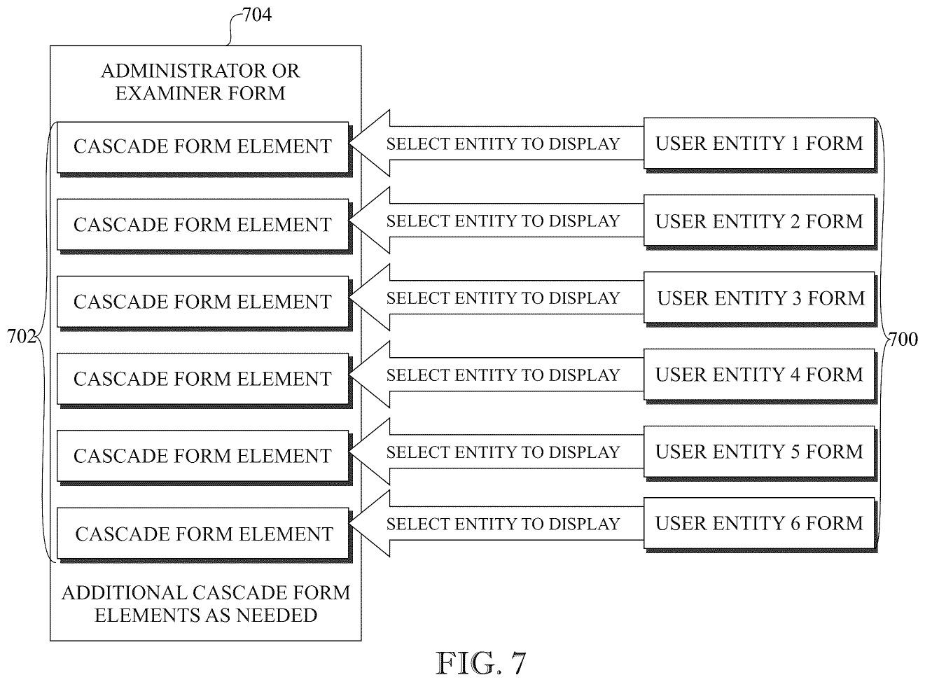

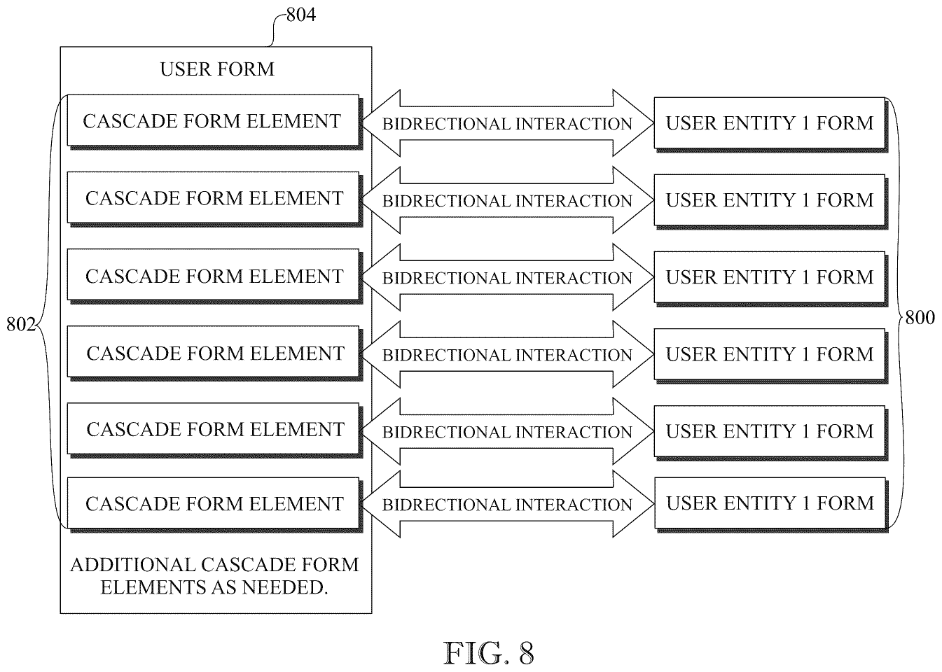

As mentioned above, one feature of the A.ITAM system 400 is the use of a cascade form field for linking the particular one form with other forms such that an input to the particular one form cascades to the other forms linked thereto and vice versa. This field allows users to connect multiple forms together creating a contiguous experience for the user's respondents. A multi-form cascading form field provides form designers and administrators the ability to connect multiple forms together rendering them as one contiguous form to the user in real time, which allows for cost and complexity reductions simultaneously improving the updateability across the entire ITAM platform and user community. The multi-form cascading primary functionalities include the form designers placing the field into position and designating the unique form identification number into the field activating the connecting of multiple forms to appear as one continuous form. The data sets from user inputs continue to be maintained in their respective form databases. If the user want to simplify really complex forms with common templates that the user “stitch” or link together. When the user place this field into position anywhere in the user's main form the user are presented with a multiple choice drop down selector containing all the active forms in the user's current inventory. The user is able to cascade multiple separate forms together. The user is also able to cascade within a cascaded form creating complex form nesting scenarios. The form fields will assume the name of the cascaded form name present in the drop-down form selector. The results of the respondent entries will stay with the specific forms cascaded together. Any form that is connected by a cascade field will independently update data when a user enters information and in addition to the separate form data set, the updates flow upwards to the top-level cascade form data set. Bi-directional data management is possible with the top-level collation of all separate form data into one unified experience and report output. These features are further demonstrated in FIG. 7 that shows an exemplary cascading form use with administrator and examiner functions in accordance with an embodiment, and FIG. 8 shows exemplary cascading form use with user functions in accordance with an embodiment. User entity forms 700 flow into and with administrator or examiner form 704 which further comprises a plurality of cascade form elements 702. Further, bidirectional interaction between a plurality of user entity forms 800 and a plurality of cascade form elements 802 associated with user form 804 is associated with user cascading features. Expanding the field properties will present these options: Choosing Form to Cascade: This is an advanced

option. The user chooses any active form from the list and automatically link it into position; and Custom CSS Class: This is an advanced option. The user can add custom CSS class names to the parent element of the field. This is useful if the user would like to customize the styling for each of the user's field using the user's own CSS code. These custom class names will not appear live in the form builder, only on the live form.

Advantageously, in accordance with the disclosed embodiments users (e.g., compliance officers, examiners and administrators) may define, submit, deploy, manage, retain, and execute their GRC platform and related content in a fully transparent and secure fashion. That is, the disclosed embodiments provide a GRC technology solution to active documents that are continuously updated and produces cybersecurity audit documentation and compliance assessments, recommendations and reports. Thus, the system and method herein manages, stores, updates, and curates pertinent regulatory codes, requirements, laws and incidental documentaries and advises on their use and impacts of ignoring such in the context of performing governance, risk management and compliance assessment. The disclosed embodiments facilitate analyzing various datasets using machine learning models for descriptive, predictive, and prescriptive purposes in improving audit, compliance, and cybersecurity outcomes. That is, the disclosed embodiments will assist in using and assessing GRC data to explain what has happened (i.e., descriptive), predict what will happen (i.e., predictive), and make suggestions about what action(s) to take (i.e., prescriptive).

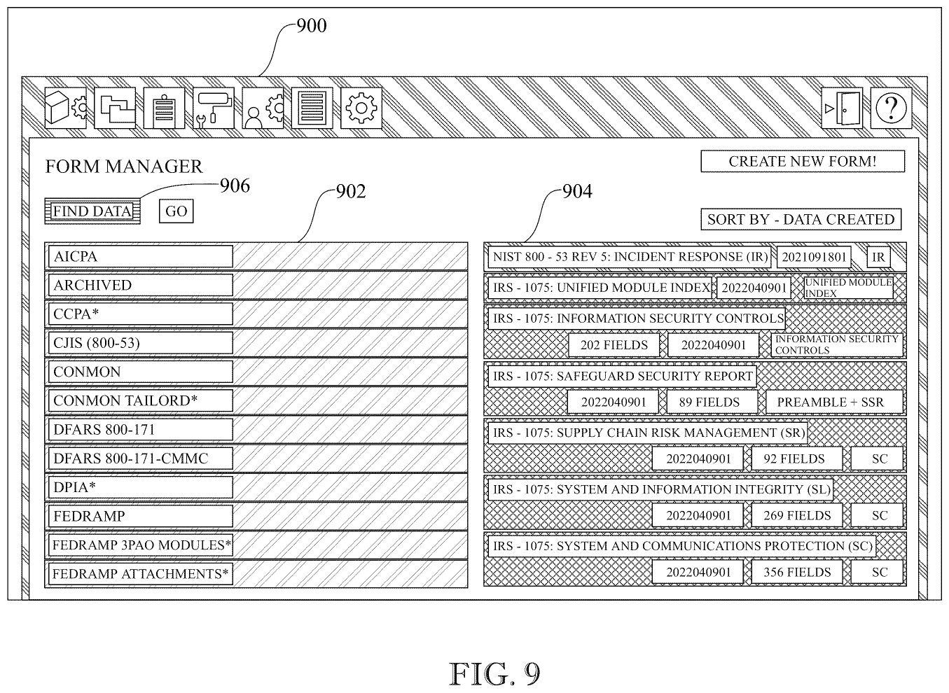

To further illustrate the above-highlighted features and advantage a number of illustrative graphical user interfaces generated by the A.ITAM system 400 will now be discussed. For example, FIG. 9 presents an illustrative form manager graphical user interface (GUI) 900 in accordance with an embodiment. As noted above, forms are an important vehicle for capturing and validating an organization's compliance data. Many organizations and agencies have used spreadsheets and free-standing documents to capture the necessary compliance information. These lacked a good way to aggregate and report on data and are difficult to keep organized. In this way, the A.ITAM system 400 replaces those legacy methodologies with highly-configurable forms that allow for the necessary information to be easily captured, reviewed and reported on. The A.ITAM system 400 forms manager (see, e.g., forms manager

432) is where those forms are kept within the system providing the functionality and flexibility needed to craft powerful forms for gathering and interacting with the an organization's data needs. As shown in the GUI 900, the user is presented with a high-level view of their available folders and forms. Using the GUI 900 a user can find and work with a specific form, create a new form, or organize the forms into folders. Further, the user may/able/disable forms, change a form's theme (i.e., a set of cascading style sheets and associated attributes to control the look and feel of the form in terms of colors, backgrounds, fonts, logo, etc.), duplicate forms, delete forms, cancel forms, and set payment options for a form (e.g., when access to a form requires a payment). Many of the options for working with a form can also be selected directly from this form manager page, though some are only available when you are editing or building a form. Folders 902 are represented in a designated font (e.g., color or cross-hatching) on the left of the GUI 900 and allow for forms to be organized together in whatever manner makes sense for the user's organization. Typically forms are organized by the standard they support; however, a folder is simply a container for forms and can be organized in different ways to support your organization's needs. These folders use an accordion style interface meaning they can be expanded and contracted by clicking on the bar which represents the folder. The A.ITAM system 400 provides for a variety of folder management functions using GUI 900 that include folder creation, moving folders, renaming folders, and deleting folders.

On the right side of the GUI 900, by default, any available forms 904 are displayed which have not yet been assigned to a folder. The section of the GUI 900 is also used to display the results when searching for a form. Whether a form is in a folder or by itself, it also acts as an accordion interface. Selecting a bar which represents a form will display or hide the various icons which are used to access the powerful array of management and editing options available for a form. Unlike folders, forms may be different colors or fonts depending on their status in the A.ITAM system 400. The find data 906 feature of the GUI 900 allows a user to search for a particular form a piece of data or data set. Illustrative search options include: (i) The Form Tags search option searches the tags associated with each form for the term used in the search; (ii) The Form Title search option searches the titles of the forms in your collection for the term used in the search; and (iii) The Form Elements search option searches within the available forms to find elements that contain the search term. This search will provide an additional option in the search

results to display the text of the elements which match the search term and link to the related form. Further, illustrative form sort options include date created, form title, form tags associated with each form, form entries on a particular day, and the most or least total entries in a form. Tagging forms allows the user to dynamically create categories and/or groups of forms based on the tag values assigned to the forms. Combined with the search capability, it allows the user to quickly find all forms that the user has tagged with a particular value, creating an association of forms that are easy to find when the user needs them.

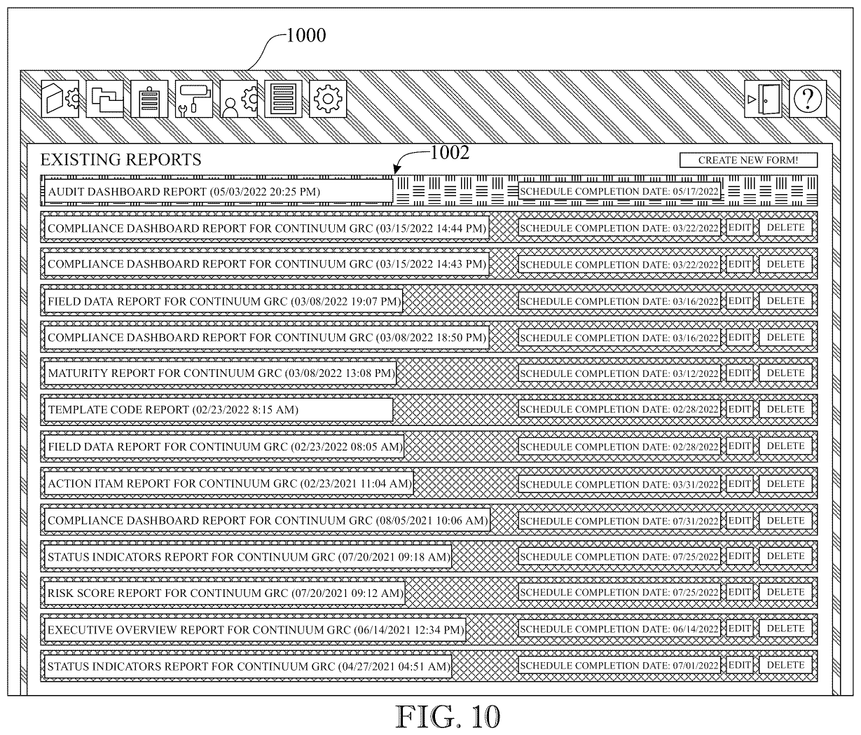

FIG. 10 presents an illustrative existing reports graphical user interface 1000 in accordance with an embodiment. Once data has been collected on a form it is necessary to present the information in a format which aids in interpreting the results. Reports are a key tool for making data meaningful and the A.ITAM system 400 comes with a number of built-in reports to facilitate understanding the data, collecting data, and identifying meaningful action(s) to take based on the results. The GUI 1000 provides a reports manager (see, the reports manager 434) for creating, editing, viewing, deleting, and managing existing reports 1002. Illustratively, an accordion view of the existing reports 1002 is provided organized by completion date of a report and displayed using a color or other unique font. Selecting a report name will expand that report to display information about the report and will display a link which allows the user to view the full report. Depending on the report type selected, it may be necessary to specify the entity for which the user is pulling the data and one or more forms in which the data resides. Some reports contain other filters as well. Various report types are available which include: (i) audit dashboard: a detail of auditable actions by both portal and administrative users: (ii) artifact management: lists the artifacts uploaded to the forms in the A.ITAM system 400; (iii) compliance dashboard: displays the compliance status of the selected entity against the selected forms as well as the detail of the current status of each field; (iv) executive overview: a high-level version of the compliance dashboard, giving a high-level view of compliance for the forms selected; (v) field data: allows the user to take one or more fields and chart the aggregate data over time; (vi) maturity: displays a summary of the maturity scores for the forms selected and lists the risk values which feed into the form; (vi) risk scores: charts the of one or more selected forms and displays the risk values which feed into the form; (vii) status indicators: compares the totals of fields in each status for the selected forms and allows you to dig into the fields which

are in each status; and (viii) template code: provides a list of the template codes for the selected forms. Some reports contain data that will be charted or compared. In those instances, a chart type selection option will be displayed, allowing the administrative user to select what type chart they wish to use to display the data including, but not limited to, line charts, area charts, column/bar charts, pie charts, bubble charts, combinations, 3D charts, sunburst charts, and polar charts. When a user is working with the field data of a report there may be a need to aggregate the data (e.g., for display purposes). The A.ITAM system 400 provides multiple computational options including: (i) entity: most reports require that they be associated with a particular entity so that it knows from where to pull the data; (ii) forms: most reports require that they be associated with one or more forms so that they know what data the administrative user wants to see; and (iii) scores: within a form, the question-type fields are designed to have a risk or weighted score assigned to each available response. Each score has a color assigned (or some other unique identifier) to it so when a user generates a report, the associated score will have a color assigned to it, for example. For example, for every 10 points, a new color is assigned with a range between 0 through 999 producing 100 color combinations.

The A.ITAM system 400 also provides for a file manager. The audit and evaluation process depends on documentation and evidence to show that an organization has achieved compliance with a control. Much of that evidence consists of files uploaded into the appropriate fields in the form of the A.ITAM system 400. These files may be images, text, affidavits, spreadsheets, or almost any other type of file which conveys the information needed. The file manager is a convenient way to see the files uploaded by an entity and interact with those files. Once an entity has been selected and the data returned it is possible that the user will receive more data than anticipated. As such, it is possible to filter the data using a search field, for example, a user may start entering a form name and the list of files will be restricted to only those which are associated with that form. The user may also sort files, download a list of files, rename a file, view/play a file (e.g., a video or audio file), download individual files, delete files, replace files, upload files, and view a filed associated with a file.

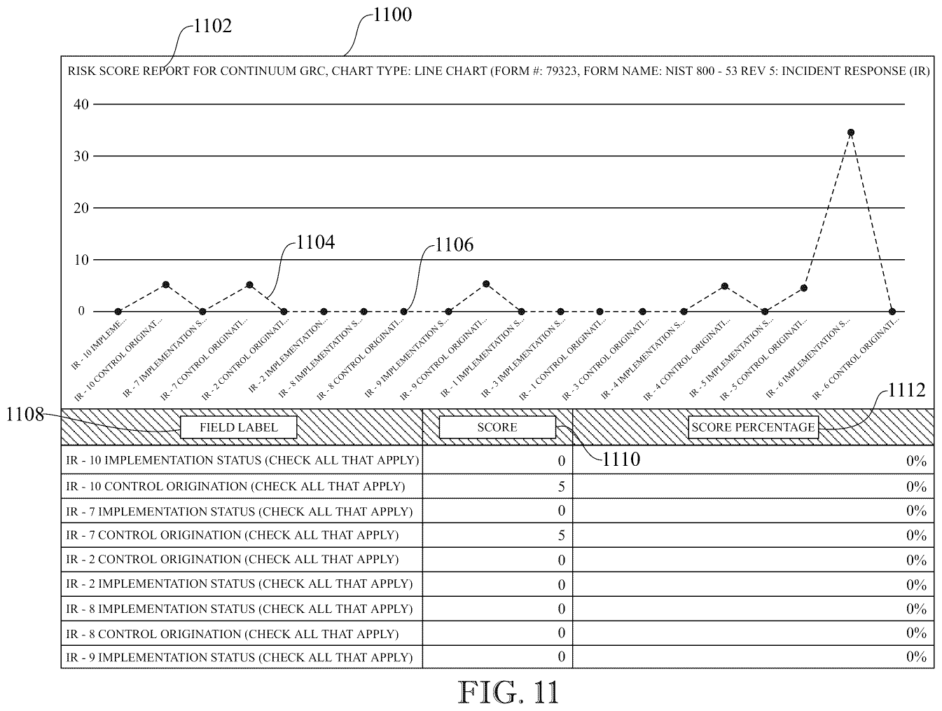

FIG. 11 presents an illustrative risk score report graphical user interface 1100 in accordance with an embodiment. The risk scores report 1102 provided a more detailed view of

the at risk scores on one or more forms. In addition to the typical header, the report includes a section for each form displaying a line graph 1104 of the chosen type plotting the risk scores 1106, and also a chart with the related data such as field label 1108, score 1110, and score percentage 1112.

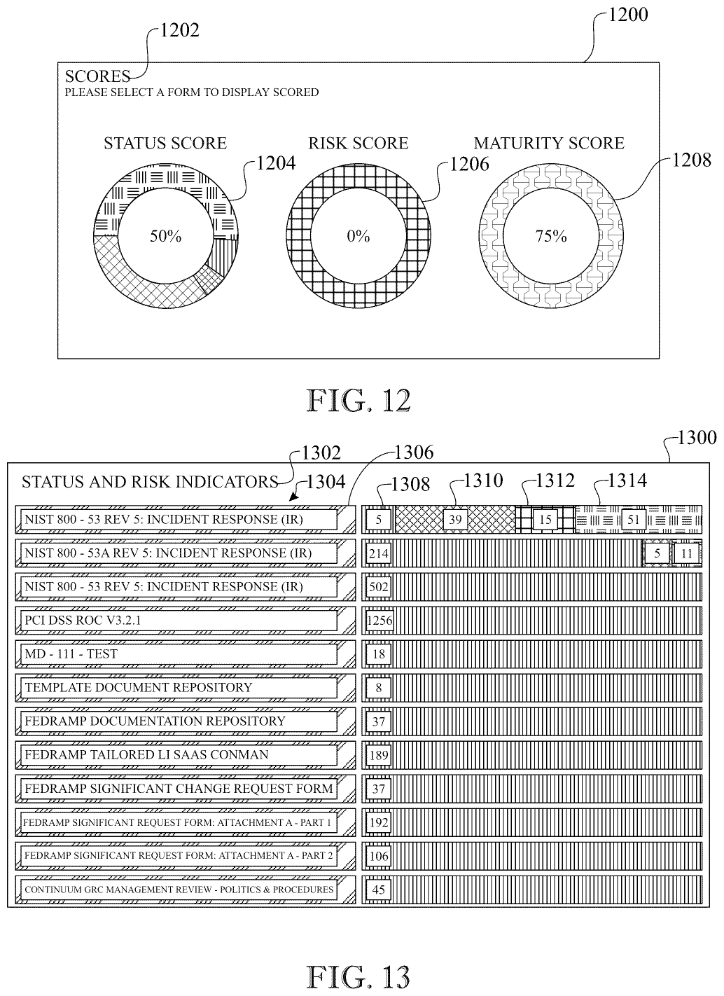

FIG. 12 presents an illustrative compliance score report graphical user interface 1200 in accordance with an embodiment. When first viewing the compliance score report GUI 1200, the score section will be empty, pending the selection of one of the forms. As soon as the user selects a form (e.g., from the dashboard), the associated scores 1202 will be displayed. The status score 1204 displays the number of fields in each status and the score which is the ratio of compliant fields to the total number of fields. The risk score 1206 is calculated based on the score of compliant scores vs less compliant scores. The maturity score 1208 is a calculation involving risk percentage and the number of compliant fields. Typically, a higher status score 1204 is better, showing better progress toward completion and compliance. A lower risk score 1206 is preferable, indicating a lower level of risk in the monitored system. A higher maturity score 1208 is desired, showing an entity has mitigated risk well and has made better progress toward compliance.

FIG. 13 presents an illustrative status and risk indicators graphical user interface 1300 in accordance with an embodiment. The status and risk indicators GUI 1300 displays forms 1304 by their name 1306 which are available to a user and some key information about their status. Further, a color-coded (e.g., grey, red, yellow and green) or unique font-coded count of the number of fields in each of the four (4) available statuses (i.e., 1308, 1310, 1312, and 1314). Form status indicators are an integral part of the governance and audit process integrated into the A.ITAM system 400. Status indicators control the state of a given control or field on a form which represents the associated entity's progress in their efforts to comply with that control. These statuses, in turn, drive many of the metrics used in tracking and reporting on the entity's overall actions toward compliance with the standard represented by the form. Typical form status indicators include: (i) gray: indicates a field or control which has either not been filled out or evaluated; (ii) red: indicates a field or control which has been evaluated and is found to need remediation; (iii) yellow: indicates a field or control which is currently in progress (a field

automatically gains this status once modified by the user; and (iv) green: indicates a field or control which has been evaluated and is found to be compliant. The order of the forms in the display can be sorted by date or the number of fields in yellow, green, or red status, for example. Status Indicators are visible in almost every screen where the individual data fields of a form can be viewed. This includes when editing a form, reviewing form data and when viewing certain types of reports. Status Indicators can only be changed by an administrator and can be accessed for editing purposes from three different views. One way to access status indicators is when viewing form data entries. The detail view of the form entry displays all of the fields in a list and includes status indicators that can be modified by an examiner or administrator.

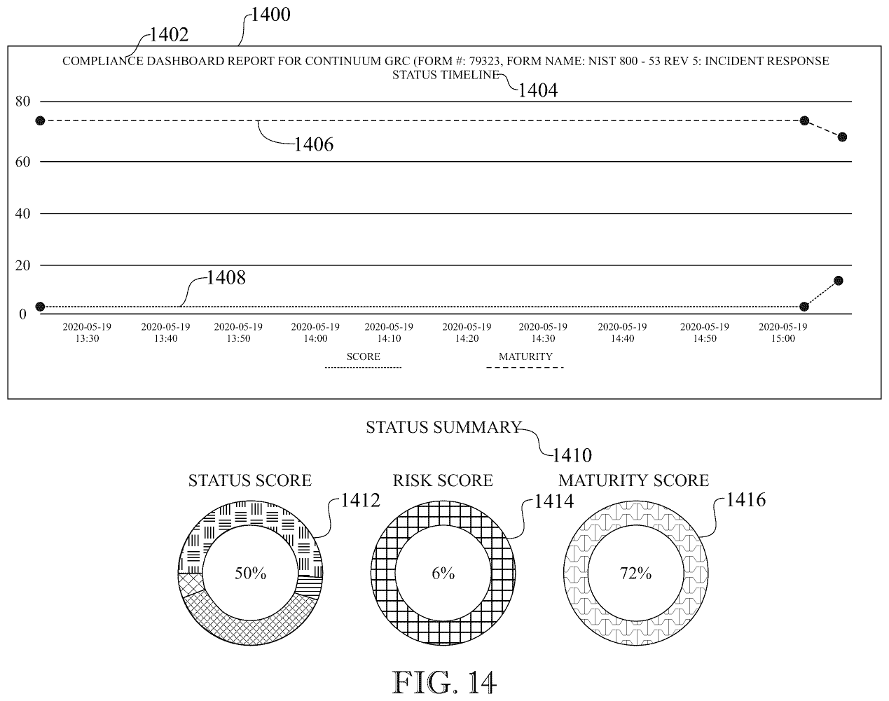

FIG. 14 presents an illustrative compliance dashboard graphical user interface 1400 in accordance with an embodiment. The compliance dashboard report 1402 provided a more detailed view of current compliance status over a certain status timeline 1404 in graphical form. In addition to the typical header, the report includes a section for each form displaying a line graph 1406 for maturity scores and line graph 1408 for risks scores. Risk is calculated based on the score of compliant scores vs less compliant scores. Maturity is a calculation involving risk percentage and the number of compliant fields. Also, a status summary 1410 is shown comprising status score 1412, risk score 1414, and maturity score 1416.

The A.ITAM system 400 and the AI cognitive machine learning algorithm subsystem 304 incorporate a number of advantageous features as detailed above. The following discussion will further illuminate such details and functionality.

A ser Portal has Standard Features, while the Administrative Portal has both Standard Features and Advanced Features. The User Portal user starts with signing-in to the ITAM User Portal Login Page and ends with signing-out in the User Portal, which incorporates Catalog, My Forms, My Documents, My Reports, Business Information, My Account, Sign Out and Help as Standard Features. The Administrative Portal user starts with signing-in to the ITAM Admin Portal Login Page and ends with signing-out in the Admin Portal, which incorporates Manage Forms, Manage Reports, Edit Themes, My Users, My Account, Settings, Sign Out and Help as Standard Features. The Manage My Users functionality includes adding users, editing a user, two-step multifactor authentication verification, delete or suspend a user, allowing a user to

create new forms, allowing a user to create new themes, allowing a user to administer ITAM and the many users main interface.

The User's Manager interface consists of a main table that displays all users with access to the user's A.ITAM. There are options here to filter, sort, delete or suspend users as well as features to automatically suspend accounts after a predefined date, to automatically suspend an account for inactivity after a predefined number of days and to automatically delete the account for inactivity after a predefined number of days of inactivity which emphasize enterprise cyber security access and authentication controls. The Manage My Account functionality includes profile password management, and two-step multifactor authentication management. In the My Account screen, users can manage basic account and logic information, accessible via the My Account tool on the A.ITAM system menu. The Manage Setting functionality includes using SMTP servers to send emails, miscellaneous settings, enforce two-step multifactor authentication on users, enable IP address restriction, enable account locking, form export-import tool, ITAM license management, enable registration notification, enable welcome message notification, enable site down, reCAPTCHA Site Key management, SAML authentication for administrators, and form exporting and importing tool.

The System Settings interface allows the admin to define a variety of system-wide settings. The Help Feature provides information to users requiring assistance with the system.

The Administrative Portal incorporates Manage Forms, Manage Reports, Edit Themes, and Manage Data. These are also User accessible. The Edit Theme feature is the ITAM's theme editor, which allows users that are granted the Create New Theme privilege the ability to customize most aspects of a form's visual appearance, which may harmonize with the customer's theme color setting and fonts, as well as other visual aspects for familiarity and branding associations. The Manage Reports functionality includes line chart, area chart, column chart, bar chart, pie chart, scatter chart, bubble chart, dynamic chart, combination chart, 3D Chart, gauges, heat map, general map, and dynamic map. Using the Create New Report tool, the Manage Report allows the user to create, manage and edit reports. Analysis and comparison of existing form data may be computed here and assigned to a user. The Manage Forms primary functionalities include searching the forms list, filtering the forms list, sorting forms, tagging

forms, enable-disable forms, changing theme, duplicating the form, and deleting the form. The main Manage Forms functions are, the Logic Builder, the Create-Edit Forms and the Web Integration. The Manage Forms secondary functionalities include, entries, theme, notifications, code, payment, cancellation, logic, report, view, disable, sort, delete, duplicate, create, and edit. The Manage Forms through the A.ITAM system Forms Manager option features a multiplicity of tools for boosting forms management efficiency, especially useful for large organizations in need of numerous custom forms.

The Logic Builder functionalities include, enable rules to show fields, enable rules to hide fields, enable rules to skip pages, enable rules to send notification emails, and enable rules to send form data to another website. An advanced feature of the Logic Builder is the built-in conditional logic functions for forms and pages. The Logic Builder is the control window from where designers are able to define specific business rules for certain types of form and page behavior. It is accessed from the advanced features tab of the drop down menu when selecting the form. Using this feature, form designers are able to dynamically show or hide fields, based on selections being made by the user and skip to a certain page. This is useful when it is necessary to display different form content to specific users without creating multiple forms with multiple redundant fields or having a single form with large number of fields. Creating logic for a form is novel and powerful because it does not require the user to program in any code or machine language.

The Enable Rules to Show or Hide Fields feature is enabled to show or hide fields on the form, based on the value of other fields. It is useful for displaying different sets of fields based on user choices. The Enable Rules to Skip Pages feature enables the user to jump into the successful page or go to any specific page, based on their choices. It is useful when the user has a multiple page form and needs to display different sets of pages based on user choices. The Enable Rules to Send Notification Emails feature is enabled to send additional notification emails to any email address or addresses based on user choices. The user may customize the email content, subject, and form addresses, based on user choices. The Enable Rules to Send Form Data to Another Website feature is enabled to send additional web-hooks to any other URLs, based on user choices.

An exemplary use of the Logic Builder includes filling out a questionnaire for vendor cyber security risk management, which requires collecting specific info from a host of third-party entities, which increases the chances for human error related to attention span limitations and fatigue. The A.ITAM system 400 is capable of directing the flow of the forms or pages, based on what the user entered or omitted. This shortens the questionnaire time if there is no need for an extended evaluation or add additional response requirements if further need for that is determined.

The Create-Edit Form feature's primary functionalities include, creating new form, tagging the forms, filtering and storing the forms, enabling and disabling a form, changing themes, duplicating the form, deleting the form, adding fields, ordering fields, field properties, form properties, field guidelines, creating a multi-page form, and custom handling and formatting with HTML. The Create-Edit Forms secondary functionalities include adding field, listing as, single line text, paragraph text, name, address, phone, email, time, date, number, price, website, multiple choice, checkboxes, matrix choice, drop down, file upload, signature, selection brake, page break, Syndication, and Form Cascading, chat, and media, most which have assigned Policy Machine Code, some of which have Choices and Scores.

The Policy Machine Code links input from a user to an underlying template document or spreadsheet attached to a given system form. This linkage takes the users response and transfers it to the document(s) in precisely the position(s) the value belongs. The template document placeholders are text based variables that match the programmed version associated with each form field element. Users are able to use this unique value to transfer and replace in multiple documents simultaneously. This saves lots of time and eliminates manual transcription errors. In other words, the machine policy code allows a user's response to be automatically transferred to a specific location on one or more documents or spreadsheets because the system matches the machine policy code of a response with a location code or variable in a document, spreadsheet, or template.

Within the Form Manager Form Creation tool are the fields available for the creation of a form. Every field that would be considered a “question” category includes a unique ability to assign a numeric score or weight to the response made ultimately by the form user in real-time.

The four choice fields work on the question field option as follows: The Multiple Choice requires the selection of one response among the presented options, The Checkboxes allow multiple choices among the presented options, The Matrix Choice allows for multiple choices among the presented options, and The Drop Down requires the selection of one response among the presented options. Once inside the choice field, the forms designer makes their selection as allowed. Using (+) or (−) buttons, to add or delete choices, the form designer clicks on the choice to make it the default selection. Said designer must enter a numeric value between 0-999 in the field adjacent to the response that may be used for risk weighing and other analytical calculation of choice. An exemplary use would be cybersecurity risk assessment, which requires the collection and calculation of weighted values assigned to risk factors. This is traditionally done by a human assessor prone to subjective evaluations, errors and omissions, inducing unwarranted organizational fear or unjustified organizational comfort of fear from or not worrying about grave errors, leading to delays and procrastinations. The A.ITAM system 400 solves this problem in minutes reliably and accurately. The risk metrics are then computed in real-time for the organization utilizing a multiplicity of default report formats. This unique process boosts efficiencies exponentially and reduces costs dramatically.

The user can add a custom variable to the parent element of the majority of form fields, which is useful when the user wishes to generate A.ITAM Policy Machine reports and documents using A.ITAM form data. These custom Policy Machine codes appear live in the form builder, but do not appear on the live form when displayed to the production user. The user data then populates the custom document templates assigned to the respective form and automatically generates a new document or documents. Exemplary use would be in cybersecurity risk assessment, which traditionally requires several weeks of manual compilation of audit and assessment data into the formal report. There is a high degree of human error involved in this with hours of long and tiresome transcription processes. The A.ITAM system 400 performs these functions rapidly, accurately and reliably in real-time.

The administrators and users with permission to create new forms begin form creation at the Form Manager page and launch the Form Builder tool. The Form Builder allows the user to select and place form design elements or fields from a multiplicity of predefined field type

elements, and define specific properties, including form-specific properties. Upon saving the design of a new form, the user is redirected back to the Form Manager page and the new form is displayed in the list of available forms.

The A.ITAM creates forms that can be integrated into an organization's existing websites and web applications. Through the use of multiple embedded code options, administrators are able to easily deploy a form from within an existing website, utilizing familiar coding methods without the need of advanced coding techniques. The user can access the Form Code interface by selecting a form from the Form Manager and then selecting the Code button on the tab below the selected form.

Using the Entry Manager, the Manage Data feature saves all user submitted data automatically. Entries (database records) can be managed via the Entry Manager. The Manage Data functionality includes view entry detail, edit entry, forward entry, filter entry, display selected fields, and export entries.

In the Admin Portal submitted forms will generate a new database record that may be viewed within the Admin View function, whereas the User Portal is collaborative, based on a single database entry, made and updated with each form submission for as long as the user is subscribed to that specific form. This allows group collaboration of updating a single form with the User Portal and individual assessment by administrators from the Admin Portal form viewer.

The A.ITAM system 400 also provides for notifications, with functionalities of email notification, notification settings interface, customizing the basic email options, and customizing the subject and content. Each form created in the herein allows for form-specific email notification or confirmation upon successful submission of a record entry using the specified form. Administrators and Form Designers have the ability to customize several email notification parameters. Access to a forms email notification is provided via the notification button or tab below the form entry in the Form Manager.

The ITAM is a SaaS (Software as a Service) executed on computing hardware—stationary or mobile—which is configured to process software instructions and data. A segregated Users Portal and Admin Portal accesses the A.ITAM system 400 though the Internet

SaaS (Cloud) platform across firewalls, intrusion prevention technology, two-step multifactor authentication access controls, assigned role based access security groups, private VLAN network segmentation using servers assigned to production, demonstration, clients, development, quality assurance and databases. The system may include massive parallel coupling, which ensures robustness and speed. A SaaS embodiment may comprise one or more of the following features: a) login, b) sign-out, c) help, d) settings, e) my-account, f) my-users, g) edit themes,
h) manage reports, i) manage data, j) notifications, and manage forms, which comprises at least one of the following functions executing means:
aa) forms logic, bb) create forms, cc) and edit forms, whereas said logic is executed in a logic builder unit, and whereas said create and edit forms are executed in a form builder unit, having at least one of the following modules:
   aaa) field adding, bbb) policy machine code, and ccc) choices-and-scores, and ddd) multi-form cascading whereas said modules commonly enable the ITAM policy machine, which, via an organization tool, enables at least one web integration means, whereas said ITAM is executed on computing hardware of at least one of the following type:
      A) stationary, and B) mobile, whereas user and admin have at least one common access to a multiplicity of said features, means, units, modules and types.

In another embodiment, there is an online method to audit and assess security risk and build forms to report and analyze entity compliance thereof using a SaaS structure comprising at least one of the following features:

b) login, b) sign-out, c) help, d) settings, e) my-account, f) my-users, g) edit themes,
h) manage reports, i) manage data, j) notifications, and k) manage forms, which comprises at least one of the following functions executing means:
aa) forms logic, bb) create forms, cc) and edit forms, whereas said logic is executed in a logic builder unit, and whereas said create and edit forms are executed in a form builder unit, having at least one of the following modules:
   aaa) field adding, bbb) policy machine code, and ccc) choices-and-scores, ddd) multi-form cascading whereas said modules commonly enable the ITAM policy machine, which, via an organization tool, enables at least one web integration means, whereas said ITAM is executed on computing hardware of at least one of the following type:
      A) stationary, and B) mobile, whereas user and admin have at least one common access to a multiplicity of said features, means, units, modules and types.

In another SaaS embodiment, online features are provided suitable to assess cybersecurity security risk, governance, risk and compliance requirement and build forms to report and analyze entity compliance thereof, having at least one or more of the following features: a) login, b) sign-out, c) help, d) settings, e) my-account, f) my-users, g) edit themes, h) manage reports, i) manage data, j) notifications, and manage forms; with executive means of aa) forms logic, bb) create forms, cc) and edit forms, whereas said logic is executed in a novel logic-builder unit; with modules aaa) field adding, bbb) policy-machine code, and ccc) choices-and-scores, ddd) multi-form cascading; while the modules commonly enable a novel ITAM policy-machine, which, via an organization tool, enables web integration means; and while the ITAM is executed on stationary or mobile computing hardware; and while the user and admin have dual access to a multiplicity of the features, means, units, and modules.

In another embodiment, the system provides unlimited versatility to unify the complex task of the ever-increasing number of stand-alone cyber security compliance, audit, risk, governance, and policy development activities into a seamless, simple, and contiguous process flow. The SaaS ITAM software application presents forms, questionnaires, and assessment modules to the user who inputs data, evidence, artifacts, and applicable information. The system then automatically creates reports, documents, and graphics formatted to comply with the organization's compliance business drivers in a fraction of the time compared to

traditional methods. The ITAM SaaS software application processes provide a novel and innovative way to overcome a traditional manual problem.

In another embodiment, the system provides improvements in creating complex questionnaires, assessments, forms, and other information gathering tasks. The disclosed method and system dynamically updates such documents, replicates similar datasets across multiple similar tasks simultaneously, and generates dynamic databases for reporting and analysis. The SaaS configuration replaces manual processes with an automated process rooted in computer technology with unlimited versatility to create cyber security, compliance, audit, risk, governance, and policy development complex questionnaires, assessments, forms and other information gathering tasks that automates the output of dynamically produced and formatted documents, graphic dashboards, mathematically calculated risk score metrics, and the compilation of a cognitive machine learning database.

SaaS ITAM structured functional processes replaces a manual process with an automated process rooted in computer technology, leveraging a cognitive machine learning database system (A.ITAM). The system offers two response options that are selectable for use as a user-selected response to a compliance question. The two choices are based on historical responses the user has made previously, and an additional response dynamically generated by the cognitive learning system compiled from a deidentified cohort of similar datasets.

As noted above, in some embodiments the method or methods described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the

machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Thus, the steps of the disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other

components as well, and that a high-level representation of some of the components of such a computer is for illustrative purposes.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A modular compliance verification and audit recording system comprising:
a system communications bus operatively connected to:
an initiation module configured to:
receive, over a network via a secure gateway, an incoming compliance data stream from at least one external electronic device, the incoming compliance data stream comprising compliance data, compliance event data, user identifiers, and context metadata;
authenticate the incoming compliance data stream by verifying at least one of:
compliance data elements based on at least one of a digital signature, cryptographic hash, and authentication token associated with the compliance event data;
an identity credential associated with the external electronic device; and
a session key associated with the external electronic device;
generate, based on the authenticated incoming compliance data stream, an authenticated event stream comprising the authenticated incoming compliance data stream, a verified source identifier, and authentication metadata indicating timestamp, credential validity, and integrity status: and
transmit, via the system communications bus, the authenticated event stream to an observation module of the modular compliance verification and audit recording system;
the observation module configured to
receive, from the initiation module via the system communications bus, the authenticated event stream;
generate operational evidence based on the authenticated event stream, the operational evidence comprising system logs, transactional records, and event timestamps;
generate, based on the generated operational evidence, an observation data stream comprising the operational evidence and a corresponding verification identifier; and
transmit, via the system communications bus, the observation data stream to a verification module of the modular compliance verification and audit recording system;
the verification module configured to:
access, via the system communications bus, a stored rule set and an associated access control profile stored in memory operably connected to the modular compliance verification and audit recording system;
receive, from the observation module via the system communications bus, the observation data stream;
validate, based on the access control profile, a permission level associated with the observation data stream;
determine a verification result, the verification result comprising a verified state or an exception condition by applying the stored rule set to the observation data stream;
generate, based on the verification result, a verification signal
transmit, via the system communications bus, the verification signal to a recording module of the modular compliance verification and audit recording system;
the recording module configured to
receive, from the verification module via the system communications bus, the verification signal,
generate, based on the verification signal, an immutable audit record signal comprising the verification signal and the operational evidence;
generate, based on the immutable audit record signal, an encrypted and immutable audit record;
store, in the memory, the encrypted and immutable audit record;
a policy and privacy manager configured to
apply, based on a predefined privacy policy and one or more data-classification parameters, a data-minimization filter and a redaction engine to the immutable audit record signal, wherein the data-minimization filter is configured to remove data elements classified as sensitive and the redaction engine configured to mask data fields corresponding to personal or financial identifiers;
generate a filtered and redacted output comprising privacy-protected audit information formatted for downstream transmission; and
transmit, via the systems communication bus, the filtered and redacted output to a communication module of the modular compliance verification and audit recording system, wherein the filtered and redacted output is configured for network delivery; and
a communication module configured to
receive, from the policy and privacy manager via the systems communication bus, the filtered and redacted output;
generate, based on the fileted and redacted output, an outbound transmission packet comprising the privacy-protected audit information and routing metadata; and
transmit the outbound transmission packet over the network via the secure gateway to the external electronic device,
wherein the modular compliance verification and audit recording system is configured to maintain privacy and data integrity of compliance information.

2. The system of claim 1, wherein the secure gateway comprises encryption circuitry configured to establish a cryptographic tunnel for ingress and egress of compliance data.

3. The system of claim 1, wherein the authenticated event stream further comprises a digital certificate chain verified by the initiation module.

4. The system of claim 1, wherein the verification module applies the stored rule set based on compliance requirements corresponding to one or more regulatory frameworks selected from HIPAA, SOC2, or GDPR.

5. The system of claim 1, wherein the recording module utilizes an immutable ledger structure comprising chained record hashes to prevent modification of stored audit records.

6. The system of claim 1, wherein the policy and privacy manager further generates a redaction log identifying each field removed or masked in the filtered and redacted output.

7. The system of claim 1, wherein the communication module comprises message-authentication circuitry configured to digitally sign the outbound transmission packet prior to transmission.

8. The system of claim 1, wherein the memory comprises a partitioned record store with discrete access domains for each of the modules.

9. The system of claim 1, further comprising an operator console configured to display verification states, exception conditions, and redaction logs generated by the modules.

10. A computer-implemented method for privacy-preserving compliance verification and audit recording, comprising:
receiving, over a network via a secure gateway, an incoming compliance data stream from at least one external electronic device;
authenticating the incoming compliance data stream by verifying at least one of a digital signature, cryptographic hash, authentication token, identity credential, or session key associated with the external electronic device;
generating an authenticated event stream comprising authentication metadata;
generating operational evidence based on the authenticated event stream and transmitting an observation data stream to a verification module;
accessing a stored rule set and an associated access-control profile;
applying the stored rule set to the observation data stream to determine a verification result comprising a verified state or an exception condition;
recording the verification result as an encrypted and immutable audit record;
applying a data-minimization filter and a redaction engine to the audit record to generate privacy-protected audit information; and
transmitting the privacy-protected audit information over the network via the secure gateway to the external electronic device.

11. The method of claim 10, wherein the authenticated event stream comprises authentication metadata comprising credential validity, timestamp, and integrity status.

12. The method of claim 10, wherein applying the stored rule set includes validating access rights for the observation data stream prior to rule execution.

13. The method of claim 10, wherein recording the verification result includes generating a hash chain across successive audit records.

14. The method of claim 10, wherein the redaction engine masks data fields corresponding to personally identifiable information and financial identifiers.

15. The method of claim 10, wherein the transmitting step includes digitally signing the privacy-protected audit information.

16. The method of claim 10, further comprising displaying verification results and redaction logs via an operator console.

17. A modular compliance verification and audit recording system, comprising:
a plurality of hardware modules interconnected via a system communications bus;
a memory configured to store rule sets, access profiles, and encrypted audit records; and
communication circuitry configured to:
receive compliance data from one or more external electronic devices via a secure network gateway;
verify and record compliance events as immutable audit records;
apply privacy and redaction controls to sensitive data elements; and
transmit privacy-protected audit information to authorized external systems,
wherein modular compliance verification and audit recording system is operable to provide end-to-end verification, recording, and privacy preservation of compliance-related data across distributed computing environments.

18. The system of claim 17, wherein the memory comprises a secure ledger partition configured to maintain integrity validation for each stored audit record.

19. The system of claim 17, wherein the communication circuitry authenticates external data sources using cryptographic tokens or certificates.

20. The system of claim 17, wherein the plurality of hardware modules include a privacy-management module configured to dynamically enforce data-minimization policies in real time.
